(19) United States
(12) Patent Application Publication
(10) Pub. No.: US 2024/0315283 A1
(43) Pub. Date: Sep. 26, 2024

(54) ISOFUCOSTEROL A KEY NUTRIENT FOR PHYTOSTEROL EATING ANIMALS SUCH AS POLLEN EATING AND ALGAE-EATING AND PLANKTON EATING ORGANISMS

(71) Applicants: APIX BIOSCIENCES, Wingene (BE); PHYTANT, Wingene (BE)

(72) Inventors: Thierry BOGAERT, Wingene (BE); Sharoni SHAFIR, Jerusalem (IL); Geraldine WRIGHT, Newcastle (GB); Jan BOGAERT, Wingene (BE)

(21) Appl. No.: 18/572,560

(22) PCT Filed: Sep. 13, 2022
(86) PCT No.: PCT/EP2022/075413

§ 371 Date: Dec. 20, 2023

(30) Foreign Application Priority Data
Sep. 28, 2021 (BE) BE2021/5759

(51) Int. Cl. A23K 20/168; A23K 50/90

(52) U.S. Cl. CPC A23K 20/168; A23K 50/90

(57) ABSTRACT

Provided is a method for feeding invertebrates or aquaculture organisms comprising: #providing a non-pollen composition comprising a nutritionally effective amount of isofucosterol, fucosterol or a mixture thereof; and #administering the non-pollen composition to invertebrates.

### BACKGROUND

Insects are increasingly used as economically important animals as pollinators and as animals capable of producing animal protein for human and animal feed cost effectively with less impact on the environment than traditional animal protein crops (birds, fish, mammals). Bees are very important in modern agriculture for the pollination of crops. Pollinators have recently been under threat due to exposure to pesticides, increased prevalence of pathogens and parasites, and changes to landscape management that reduce the abundance of naturally occurring floral pollen.

Beekeepers have historically fed honeybee colonies with a food source that contains pollen or pollen collected in natural or agricultural ecosystems by honeybees. Pollen collection is limited in availability and scale. Firstly, pollen collection is costly. Secondly, pollen is hard to keep fresh. Finally, pollen collected in natural or agricultural ecosystems can carry pests, diseases, and pesticides. Therefore, commercially available feeds for bees usually do not contain pollen.

However, lack of pollen in sufficient quality and quantity is a fundamental reason for observed declines in bee colony health and survival. Honeybees harvesting natural pollen resources impose pressure on resources for wild bee species and are likely to contribute to their population declines. Transport of beehives to pollen areas is a fundamental stressor to bee-colonies and a major cost to the beekeeping industry. A pollen replacement designed for domesticated bee species would address these issues.

Bees derive essential nutrients such as sterols from pollen. These sterols are likely to include cholesterol, campesterol, Beta-sitosterol or stigmasterol. Original work at the USDA Beltsville laboratory in the 1970's describes the utilization of sterols derived from pollen by honeybees that are fed a synthetic diet (Journal of Insect Physiology, Vol, 26, pp. 287-289). Chakrabarti et al. describe a role of 24-Methylenecholesterol in honeybee nutrition (Chakrabarti, Evaluating effects of a critical micronutrient (24-Methylenecholesterol) on honeybee physiology, Annals of the entomological society of America, Vol 113, 176-182, 2019). However, all these experiments have been performed with additions of single sterols to an otherwise sterol free diet. To date it has not been described which of the many sterols and which sterol combinations and concentrations are important or essential for bees.

US2019/0090507 to Apix Biosciences stresses the importance of plant sterols and, in particular, of 24-Methylenecholesterol, campesterol, β-sitosterol, and cholesterol. However, US2019/0090507 does not disclose isofucosterol nor fucosterol or a mixture thereof with sterols as important nutrients required to create a ‘complete’ feed for domesticated bees as a feed supplement.

Mishyna et al., Journal of Functional Foods 76 (2021) 104316, doi.org/10.1016/j.jff.2020.104316, discusses studies on the consumption of insects and shrimps in respect of hydrolysates, their antioxidant and angiotensin-converting enzyme inhibitory activities, fatty acids, cholesterol, minerals, vitamins, carotenoids, phenolic compounds, dietary fiber. However, this document does not mention isofucosterol.

Soy protein or other used protein sources such as potato contain campesterol, Beta-sitosterol, stigmasterol and trace amounts of desmosterol and isofucosterol (60 mg isofucosterol/kg wet weight of potato, or 0.006%). (Sirpa O. Kärenlampi, Philip J. White, in Advances in Potato Chemistry and Technology, 2009) The concentration of sterols in these sources is below bee nutritional requirements.

In honeybees, isofucosterol makes up 10-50% of their total corporeal sterols. This amounts to 0.02-0.06% of the dry weight of a honeybee. (Svoboda et al. Utilization and metabolism of dietary sterols in the honeybee and the yellow fever mosquito, Lipids Volume 17 number 3, 1982; our data). In bumblebees such as Bombus terrestris, isofucosterol represents between 40-55% of their corporeal sterols. This quantity amounts to 0.10-0.25% of the total dry weight of a bumblebee.

Current artificial diets for bees are incomplete resulting in an initial boost of brood production followed by a rapid terminal decline in brood production over 22-40 days. This indicates that current diets lack one or more essential nutrients. However, to date there is no described artificial (pollen free) feed for bees that can support a colony's sealed brood development for more than 3 to 4 cycles of 21 days. The ability of a feed to support continuous long term brood development is a key indicator of its equivalence to pollen and its ability to act as “complete feed”. The best published data already shows a strong reduction in brood production starting after cycle 2 (Herbert et al. (1980), J. Insect Physiol., Vol. 26, pp. 287 to 289; doi.org/10.1186/s12917-022-03151-5; Bee Culture Education: Honeybee Nutrition—Randy Oliver—Part 1 to 4, Youtube). Therefore, since there is a shortage in quality and quantity of pollen in many areas where bees are kept for pollination or honey production there is a need to provide compositions and methods for feeding bees in view of maintaining a colony long term on an artificial diet whereby bees continue to produce brood indefinitely.

Current pollen free artificial diets for bees are incomplete, so bees fed on these diets are deprived or depleted of essential nutrient reserves after 3-4 cycles of 21 days of brood production in the colony (Herbert et al. (1980), J. Insect Physiol., Vol. 26, pp. 287 to 289). Here we show that addition of isofucosterol/fucosterol is required to obtain a diet that maintains brood production and colony development in a colony for more than 4 cycles suggesting isofucosterol overcomes the lack of one or more essential nutrients seen in current artificial diets. This shows that this invention results in a new diet supplying the bees with the necessary limiting ingredient/s they need. Therefore, such pollen free diet sustains a colony for extended periods of the colony's lifecycle without natural pollen, which is a significant development that can radically improve beekeeping practices.

Bees are very important in modem agriculture for the pollination of crops. Pollinators have recently been under threat due to exposure to pesticides, increased prevalence of pathogens and parasites, and changes to landscape management that reduce the abundance of naturally occurring floral pollen.

Beekeepers have historically fed honeybee colonies with a food source that contains pollen or pollen collected in natural or agricultural ecosystems by bees. Because pollen collection is limited in availability and scale, pollen collection is costly, pollen is hard to keep fresh and pollen collected in natural or agricultural ecosystems can carry pests, diseases, and pesticides. Therefore, commercially available feeds usually do not contain pollen.

These pollen substitute compositions have already been described by the present inventors.

US2019/0090507 to Apix Biosciences stresses the importance of plant sterols and, in particular, of 24-Methylenecholesterol, campesterol, β-sitosterol, and cholesterol. However, US2019/0090507 does not disclose isofucosterol nor fucosterol or a mixture thereof as bee nutrient.

### SHORT DESCRIPTION OF THE INVENTION

Whereas only a few sterols exist in animals, with cholesterol being by far the major one, in plants a wide range of sterols are found. Structural variations between these arise from different substitutions in the side chain and the number and position of double bonds in the tetracyclic skeleton. Plant sterols can be grouped by the presence or absence of one or more functionalities. For example they can be divided into three groups based on ethylation levels at C4 as follows: 4-desmethylsterols or end product sterols, 4 alfa-monomethyl sterols and 4,4-di-ethylsterols. Naturally occurring 4-desm-ethylsterols include sitosterol, stigmasterol, brassicasterol, campesterol, avenasterol and isofucosterol. In most higher plants, sterols with a free 3-hydroxyl group (free sterols) are the major end products. However, sterols also occur as conjugates, for example, where the 3-hydroxy group is esterified by a fatty acid chain or phenolic acid to give a steryl ester. For the purpose of this description, the term sterol refers both to free sterols and conjugated sterols. However in this specification references to levels, amounts or percentages of sterol refer to the total weight sterol groups whereby the weight of the conjugating groups such as fatty acid or phenolic acid is excluded. In this document fucosterol is defined as fucosterol or its isomer isofucosterol or a mixture of the two isomers. In this document isofucosterol is defined as isofucosterol or its isomer fucosterol or a mixture of the two isomers.

When described in this document a dose or amount fed is as x grams (or other quantity) in a two week period (or other time period), this is intended as general description of “dose given in a unit of time” and not a specific limitation the specific requirement to feed on a two weekly basis. A skilled person can recalculate a weekly dose regiment into daily or biweekly dose or any similar time period.

The present inventors have surprisingly established that isofucosterol is an essential nutrient for bees. Isofucosterol delivered through a pollen-free diet increases bee brood production and survival of worker bees as compared to an isofucosterol-free non-pollen bee diet.

The present inventors have surprisingly established that isofucosterol is an essential nutrient for bees. Isofucosterol delivered through a pollen-free diet increases bee brood production and survival of worker bees as compared to an isofucosterol-free pollen substitute bee diet. The present inventors have further found that the combination of isofucosterol and at least one further sterol, in particular cholesterol, 24-Methylenecholesterol, and other phytosterols, in particular campesterol, beta-sitosterol or stigmasterol delivers higher growth and/or health performance in invertebrates, in particular bees and other pollen eating insects than isofucosterol alone.

This utility hereof is important in the formulation of non-pollen feed to supplement honeybee colonies in periods of pollen dearth in the environment (which is today a major source of poor performance of bee colonies), in the production of superior honeybee queens and in the commercial rearing of pollen eating insects such as black soldier flies as alternative protein source for human and animal feed, bumblebees (for pollination), ladybird beetles (for aphid control); hoverflies (for pollination) and other commercially relevant insects.

However, commercially available bee feed compositions do not contain isofucosterol as shown in comparative example 1. Consequently, the present invention is the first demonstration that the addition of isofucosterol to a non-pollen bee diet is advantageous.

Accordingly, a first aspect of the invention is a method for feeding invertebrates or aquaculture organisms comprising:
providing a non-pollen composition comprising a nutritionally effective amount of isofucosterol, fucosterol or a mixture thereof; and
administering the non-pollen composition to invertebrates.

In another aspect, the invertebrates are pollen eating insects, preferably insects of the orders Hymenoptera and Coleoptera, more preferably honeybees, bumblebees, black soldier flies, hoverflies, or ladybirds,

In another aspect, the aquaculture organisms are plankton and algae eating aquaculture organisms, preferably fish, fish larvae, oysters, clams, molluscs, gastropods, or crustacea.

In another aspect, the nutritionally effective amount of isofucosterol, fucosterol or a mixture thereof is a daily dose of 0.0006 w % to 0.052 w % of the life bodyweight of the invertebrates or aquaculture organisms.

In another aspect, the nutritionally effective amount of isofucosterol, fucosterol or a mixture thereof is from 10 w % to 60 w % of the total amount of sterols of the group of isofucosterol, fucosterol, cholesterol, 24-Methylenecholesterol, campesterol, stigmasterol and beta-sitosterol in the total diet of the invertebrates or aquaculture organisms or the pollen substitute composition.

In another aspect, the isofucosterol, fucosterol or a mixture thereof is administered in a ratio of 0.14 g to 12 g of isofucosterol, fucosterol or a mixture thereof per 30000 bees per period of two weeks.

In another aspect, the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-sitosterol in the total diet of the invertebrates or aquaculture organisms or of the pollen substitute composition.

In another aspect, the nutritionally effective amount of the isofucosterol, fucosterol or a mixture thereof is an administration ratio of 0.2 to 48 grams per 30000 bees per a time period of two weeks.

In another aspect, the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-sitosterol in the total diet of bees or of the pollen substitute composition.

In another aspect, the isofucosterol, fucosterol or a mixture thereof is administered in a ratio of 0.4 g to 36 g per 30000 bees per a time period of two weeks.

In another aspect, the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-sitosterol in the total diet of bees or of the pollen substitute composition.

In another aspect, the isofucosterol, fucosterol or a mixture thereof is administered in a ratio of 0.6 g to 20 g per 30000 bees per a time period of two weeks.

In another aspect, the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-sitosterol in the total diet of bees or of the pollen substitute composition.

In another aspect, the isofucosterol, fucosterol or a mixture thereof are administered in an amount of 0.001 w % to 0.087 w % of the life weight of the invertebrates or aquaculture organisms per day.

In another aspect, the nutritionally effective amount is:
isofucosterol in an amount of 10 w % to 60 w %,
cholesterol in an amount of 0 w % to 50 w %,
24-Methylenecholesterol in an amount of 0 w % to 50 w %,
beta-sitosterol, stigmasterol and/or campesterol in an amount of 0 w % to 50 w %
   as compared to the total amount of isofucosterol, fucosterol cholesterol, 24-Methylenecholesterol, beta-stigmasterol, stigmasterol and/or campesterol.

In another aspect, the total concentration of sterols is from 0.01 w % to 4 w %, preferably from 0.05 w % to 3 w % and even more preferably from 0.05 w % to 2 w %, and even more preferably from 0.05 w % to 1.5 w % as compared to the total weight of the pollen substitute composition.

In another aspect, the concentrations of sterols are chosen from the group of:
Cholesterol in an amount from 0.001 w % to 2 w %, preferably from 0.001 w % to 1.5 w %, more preferably from 0.06 w % to 1.2 w % as compared to the total weight of the pollen substitute composition,
24-Methylenecholesterol in an amount from 0.001 w % to 2 w %, preferably 0.001 w % to 1.5 w %, more preferably from 0.06 w % to 1.2 w % as compared to the total weight of the pollen substitute composition,
Sitosterol, preferably beta-sitosterol in an amount from 0.001 w % to 2 w %, preferably from 0.001 w % to 1 w %, more preferably from 0.03 w % to 0.6 w % as compared to the total weight of the pollen substitute composition,
Isofucosterol in an amount from 0.01 w % to 5 w %, preferably from 0.01 w % to 2 w %, more preferably from 0.01 w % to 1.0 w %, more preferably from 0.03 w % to 0.6 w % as compared to the total weight of the pollen substitute composition,
Campesterol in an amount from 0.001 w % to 2 w %, preferably from 0.001 w % to 1 w %, more preferably from 0.02 w % to 0.35 w %, as compared to the total weight of the pollen substitute composition,
Stigmasterol in an amount from 0.001 w % to 2 w %, preferably 0.001 to 1 w %, more preferably 0.01-0.2%, as compared to the total weight of the pollen substitute composition, or
any combination thereof.

In another aspect, the composition is a whole invertebrate diet, part of an invertebrate diet or a dietary supplement and wherein the ratio of 24-Methylenecholesterol to the further sterol or to the combination of further sterols is from 10:1 to 1:1.

In another aspect, the composition is administered to invertebrates of the Apidae families, in particular honeybees (Apini), bumblebees (Bombini), or stingless honeybees (Meliponini).

In another aspect, the composition is a whole invertebrate diet, part of an invertebrate diet or a dietary supplement.

In another aspect, the composition is administered to invertebrates of the Apis or Bombus genera, in particular honeybees or bumble bees.

In another aspect, the composition is administered
in solid form such as a patty or in liquid form such as a solution or spray,
inside or outside the hive.

In one embodiment, the composition is substantially pure, i.e. consists of 50 w % or more, preferably 70 w % or more, even more preferably 90 w % of the of the group of isofucosterol, fucosterol, cholesterol, 24-Methylene cholesterol, campesterol, stigmasterol and beta-sitosterol in the total diet of bees or of the pollen substitute composition.

In another aspect, the source of the isofucosterol, fucosterol or a mixture thereof is a non-pollen tissue of one or more plant species selected from the group consisting of leaves, stems, roots, tubers, flowers, seeds, barks and fruits and combinations thereof.

In another aspect, the source of the isofucosterol, fucosterol or a mixture thereof is an extract, an oil, or a refinement of a non-pollen tissue of one or more plant species or a combination thereof.

In another aspect, the source of the isofucosterol, fucosterol or a mixture thereof is a non-pollen tissue of one or more plant species selected from the group consisting of Solanaceae, Poaceae, Ranunculaceae, Fabaceae, Corylaceae.

In another aspect, the source of the isofucosterol, fucosterol or a mixture thereof is a non-pollen source selected from the group consisting of:
a marine or freshwater algal species, in particular an extract, an oil or a refinement of Ulva lactuca,
a marine diatom species, in particular an extract, an oil or a refinement of Thalassiosira pseudonana, Thalassiosira rotula, or Chaetoceros muelleri; and
a fungus, in particular an extract, an oil or a refinement of Saccharomyces cervesiae, or Yarrowia lipolytica.

In another aspect, the isofucosterol or fucosterol is chemically orenzymatically synthesized or obtained by genetically modified host organisms such as fungi, bacteria, or algae.

In another aspect, the source of the isofucosterol, fucosterol or a mixture thereof is selected from the group consisting of algae, plant, fungus, algae, diatom and combinations thereof and wherein source of the isofucosterol, fucosterol or a mixture thereof is a non-pollen tissue.

In another aspect, the isofucosterol, fucosterol or a mixture thereof is provided to a eusocial, or primitively eusocial, bee colony from a synthetic source.

In another aspect, the isofucosterol, fucosterol or a mixture thereof is provided as part of a pollen substitute composition, wherein the pollen substitute composition comprises:
proteins in an amount from 10 w % to 50 w %, preferably of 20 w % to 40 w %,
fatty acids in an amount from 1 w % to 20 w %, preferably of 2 w % to 12 w %,
carbohydrates in an amount from 30 w % to 90 w %, preferably of 5 w % to 15 w %,
optionally vitamins, and
optionally minerals,
   wherein the total amount of components and optionally further components add up to 100 w % and wherein the w % are related to the total dry weight of the composition.

In another aspect, the isofucosterol, fucosterol or a mixture thereof are provided as part of a pollen substitute composition, wherein the pollen substitute composition comprises:
proteins in an amount from 10 w % to 50 w %, preferably of 15 w % to 40 w %,
fatty acids in an amount from 1 w % to 20 w %, preferably of 2 w % to 12 w %,
carbohydrates in an amount from 20 w % to 90 w %, preferably of 30 w % to 70 w %,
optionally vitamins, and
optionally minerals,
wherein the total amount of components adds up to 100 w % and wherein the w % are related to the total dry weight of the composition.

In another aspect, the composition comprises of isofucosterol or fucosterol or mixtures thereof in an amount from 0.01-5% of the diet, preferably from 0.01-1% and even more preferably from 0.03-0.5% for honeybees and 0.03-0.8% for bumblebees as a percentage of the total weight of the pollen substitute composition or In another aspect, the composition is essentially free of pollen.

Another aspect is the use of the pollen substitute composition of the invention for feeding an organism selected from the group consisting of
invertebrates, preferably insects of the orders Hymenoptera and Coleopera, even more preferably honeybees, bumblebees, black soldier flies, or ladybirds.
aquaculture organisms, preferably plankton and algae eating aquaculture organisms, more preferably fish, fish larvae, oysters, clams, molluscs, gastropods, or crustacea.

Another aspect is the use of the pollen substitute composition of the invention as a concentrated patty, wherein the concentration of isofucosterol, fucosterol is from 10 w % to 33 w % as compared to the total weight of the pollen substitute composition.

In another aspect, the pollen substitute composition comprises the bee appetite/consumption inducing constituent selected from the group consisting of pollen, sugar, oil or fat, honey, or protein or a mixture thereof. In case of other invertebrates a different appetite/consumption inducing constituent can be used.

In another aspect, the concentration of the bee appetite/consumption inducing constituent is from 1 w % to 20 w %, preferably from 2.5 w % to 15 w %, even more preferably from 5 w % to 10 w % as compared to the total weight of the pollen substitute composition.

In another aspect, the pollen substitute composition is used in liquid form or powder.

In another aspect of the use as liquid form or powder, the concentration of isofucosterol, fucosterol, is from 0.01 w % to 99 w % as compared to the total dry weight of the pollen substitute composition.

FIG. 7 shows the results of Example 5A: Feeding adult Black soldier flies with a diet containing a multiplicity of sterols: effect on hatching rate of the eggs laid and the weight of the egg mass laid. Adult survival and number of egg masses laid from a population fed with a pollen substitute diet (as specified in US2019/0090507 to Apix Biosciences) was measured daily using the methods of rearing described in Thinn and Kainoh 2022. JARQ 56 (2), 211-217 (2022).

FIG. 8 shows the results of Example 5B: Feeding adult Black soldier flies with a diet containing a multiplicity of sterols: effect on adult longevity and larval survival to prepupae stage. Black soldier fly (BSF) larvae were fed with a diet containing 22% protein, 4% fat as described in Hogsette 1992. J. Econ. Entomol. 85(6): 2291-2294 until ecclosion. Sterols were sourced as pure compounds added directly to diet to a total quantity of 0.1%. Larvae and adult survival over a 50-day period measured as in Georgescu et al., Eur. J. Entomol. 118: 297-306, 2021.

FIG. 9 shows the results of Example 5C: Feeding adult Black soldier flies with different diets containing a multiplicity of sterols: sterols found in in the tissues of black soldier flies fed with a multiplicity of sterols. Sterols were added to diet. Measurement of sterols in tissues was performed after saponification of BSF tissues using GC-MS as described in Boukid et al. 2022. Insects 12, 672.

FIG. 10 shows the results of Example 6: Feeding honeybee colonies in an Apidea experiment with a diet containing an extract of Black soldier flies that were fed a multiplicity of sterols.

### SHORT DESCRIPTION OF THE DRAWINGS

FIG. 1 shows the choice of cohorts of bees of diet with or without isofucosterol.

FIG. 2 shows represents the survival of cohorts of bees confined to feed on diets containing specific concentrations of isofucosterol.

FIG. 3 shows the threshold for the influence of isofucosterol in bee diet.

FIG. 4 shows the results of Example 4A: a long-term feeding experiment in Apidea colonies with bees fed a multiplicity of sterols including isofucosterol and 24-Methylenecholesterol.

FIG. 5 shows the results of Example 4B: Results of a long-term feeding experiment in Apidea colonies with bees fed a multiplicity of sterols without isofucosterol but including 24-Methylenecholesterol.

FIG. 6 shows the results of Example 4C: Results of a long-term feeding experiment in Apidea colonies with bees fed a multiplicity of sterols whereby the total concentration of sterols in the diet is kept constant and the presence (concentration) of specific sterols is varied between diets.

### DETAILED DESCRIPTION OF THE INVENTION

Embodiments of the present inventions are described hereinafter.

Embodiments of the present inventions are described hereinafter.

Honeybees live in colonies. In standard industrial practice there are different sizes of colonies: an 8 frame colony which is industry standard contains ˜20000 bees; a 10 frame colony ˜24000; a large colony 12.5 frames in two stories=30000; a colony with 2 supers 50000 bees). Overall bee colonies have a variable size (+/−50% size increase/decrease around the year average depending on season and nutritional availability).

Rortais et al. 2005 (Apidologie, 36(1), 71-83), reviewed the bee's pollen consumption literature comprehensively and noted 10 up to 55 kg collected annually per colony. Crailsheim et al. 1993 (J Insect Phys 38(6):409-419) calculated the annual pollen consumption in two colonies to be 13.4 and 17.8 kg respectively in colonies of about 25000 bees in June-August. Wille et al. 1982 (Revue Suisse de Zoology 4: 897-914) recorded 10 to 26 kg pollen per year. It obviously depends on the colony size, colony development, environment and pollen type.

Keller et al. 2005 (Bee world, 86(1): 3-10) estimate that each worker bee requires between 140-180 mg pollen during its entire lifetime. If an entire colony raises between 100-200 k bees per year, this would result in a demand of 17-34 kg of pollen per colony. Crailsheim et al. 1993 (J Insect Phys 38(6):409-419) summarized the amount of pollen consumed per colony from 5 published articles. They also measured pollen consumption from two colonies that they measured. They estimate that the mean quantity of pollen needed for a colony producing ˜150000 brood per year is 19 kg.

When bee colonies receive supplementary feeding in periods of pollen dearth, they typically receive supplementary food in the form of a protein patty or pollen patty, (most feeding regimes are “ad libitum”) resulting in a consumption of ˜1.5 to 2 to—3 pounds (0.680-1.35 kg) per 12.5 frames per 2 weeks. In the industry a frame of bees is defined as ˜2400 bees (30000 bees in the colony) and the hives used in the industry can contain 5 or 8, 10 or 12 frames or even more. In the beginning of the spring season a hive is only partially populated (e.g., 5 frames of bees in a 10-frame hive) and as the season proceeds the bee population in that hive then expands to fill the 10-frame hive with 10 frames of bees. During the winter the colony then decreases its population to 5-6 frames of bees.

In calculating the dose of “mg pollen equivalent feed” required by bees, one needs to consider that pollen from different plant species contains a wide range of ˜50% sugar, protein and other constituents and that therefore the nutritional value of pollen varies by plant species (range +/−50%). Through supplementary feeding of pollen, pollen supplements or protein supplements, colonies receive a dose of ˜1.5-˜3 lb or (680 g to 1360 g) of pollen supplement per two weeks. On an annual basis this amounts to a range of 17.7 kg to 35.4 kg of pollen supplement food which is in range with published figures for a 10-frame colony eating pollen considering the variable nutritional qualities of pollen. For colonies of different size, the dose calculations are proportionally adjusted. (1 bee frame=˜2400 bees).

Calculated based on the table from Roessink et al 2021 (J Apic Res 60: 659-654) a 30000-bee colony consumes 62 grams of pollen per day or 868 gram per 2 weeks (in the active flowering & bee multiplication season).

A more extensive description is given by the text and table in quotes below from: https://www.insignia-bee.eu/how-much-pollen-does-a-colony-need/

“Rortais et al. (2005), reviewed the bee's pollen consumption literature comprehensively and noted 10 up to 55 kg collected annually per colony. Crailsheim et al., calculated the annual pollen consumption in two colonies to be 13.4 and 17.8 kg respectively in colonies of about 25000 bees in June-August. Wille et al., recorded 10 to 26 kg pollen per year. It obviously depends on the colony size, colony development, environment and pollen type. For example, pollen of maize is consumed in about the double amount compared to mixed pollen, due to its relative low percentage of nutrients of the whole pollen grain. The percentage protein of the dry weight is comparable to mixed pollen (Höcherl et al, 12012). Obviously, there is no fixed amount a colony could or should collect to grow, maintain and function. Nevertheless, there good studies available to assess the annual pollen need for a colony. Based on the aforementioned Rortais et al. (2005) article, a nurse bee consumes on average 65 mg pollen and a worker-larvae 5.40 mg. Consequently, a bee consumes in her life minimally 70.4 mg. This is the average estimation; double amounts have been reported as well. In the aforementioned Crailsheim et al study the pollen consumption per day was 3.4 to 4.3 mg. In a 30-days life span of the summer honeybee this is approximately 115 mg in her lifespan. Another approach to assess pollen consumption is presented in the review article of Keller et al., (2005a). It is the assessment of pollen consumption based on nitrogen (N) in brood and bees. Pollen is the solely N source in the bee's diet. To convert N to pollen, it is assumed that the pollen protein contains 16% nitrogen, that pollen contains 20% protein, and that the digestive efficiency is 80%. So, for 10 mg N, it takes 62.5 mg protein; for 62.5 mg protein it takes 312.5 mg pollen and by the efficacy of the alimentary process it takes 390.6 mg pollen consumed by the bee. Taking all this into account it takes 125 mg pollen to raise a bee. The N in the bees after emergence, increases by 0.86 mg. The 0.86 mg N correspond to 39 mg pollen. Therefore, in total each bees required minimally 125+39=164 mg pollen as N loss by defecation is not taken into account. Counting the bee's active and reproducing period on 200 days and the average life span of a bee of 35 days (Steen et al, 2012), it takes 200/35=6 generations. To maintain a colony of on average 15000 bees, 15000×6=90000 bees are raised. The number of bees raised annually, and the calculated amount of pollen required are summarized in table 1 [of this article].

The 35 kg mentioned in the beginning is the amount required for a big colony and is an optimal estimation. Amounts varying between 15 and 25 looks more realistic. Again, it all depends on pollen type, environment, colony development and yes/no pollen trap. Depriving colonies from pollen stimulated pollen collection. It is up to the beekeeper to maintain an adequate pollen flow. To check whether the pollen stores are sufficient it simply takes a rough estimation of the surface/number of beebread cells in a colony. A healthy normally sized colony needs/consumes per day about 0.5 to 2 dm² (200-800 half-full beebread cells). Another simple estimation is weighing the harvest of the pollen trap. It must be taken into account that the efficacy of the pollen trap varies between 10 and 50% (Keller et al., 2005b).

Table 1 from Roessink et al 2021, Beebread consumption by honeybees is fast: results of six-week field study, Journal of Apicultural Research, 60:659-664, shows an exemplary calculation of pollen requirement by a bee hive based on the consumption of pollen per day for a given size of colony. The larvae and nurse bees are the consumers of pollen. The older worker bees consume honey/nectar.

Pollen represents the natural food source for honeybees and pollen eating insects. Pollen is not optimized by the plant to feed insects (it is optimized for plant use=fertilisation). Pollen from different species contains a wide range of different protein, lipid, sterol, antioxidant molecules at widely different concentrations. Therefore, it is not yet known which of these constituents are beneficial and which ones are plant defense molecules to stop insects feeding on pollen and which are not important ingredients for insect nutrition and hence which are important to include and which are important to exclude from an artificial diet.

The inventors showed that the addition at a dose calculated for a colony of 30000 bees of between 0.14 to 12 grams isofucosterol over a 2-week period is beneficial to the performance of the colony and the bees (as seen in the production of bee brood and other fitness parameters such as longevity). This dose represents a concentration 0.01% to 1.76% isofucosterol in a 680-gram patty fed over a two-week period to a 30000-bee colony.

Calculated on a per non pollen supplement consuming bee in the hive (=the nurse bees=50% of the bees in the hive); this represents a dose of 140 mg/15000 bees=0.009 mg to 12000 mg/15000 bees=0.8 mg isofucosterol or fucosterol per nurse bee per 14 days in the hive (a nurse bee weighs 110 mg). This represents in % of bodyweight per day a dose of isofucosterol or fucosterol of 0.009/110*100/14=0.0006% to 0.8/110*100/14=0.052%.

Furthermore, the inventors show that the dose of isofucosterol or fucosterol of 0.0006% to 0.052% of bodyweight per day is beneficial to the production of larvae and adults of other pollen eating insects such as bumblebees, black soldier flies adults and larvae; lady bird beetle adults, hover flies and other pollen eating insects. In particular, it is important for adult fecundity and fertility and higher hatch percentage and survival of young larvae.

The administration form affects the efficiency of uptake and bioavailability.

### Methods of Administration

The administration to a bee colony or organism can be only for the period when a desired effect is needed: as short as a single administration to improve, induce or support normal brood development as bees come out of the winter, to induce or support queen breeding or when an insect needs to produce gametes or eggs, it can be for longer periods when bees are fed on a crop that produces nutritionally poor pollen (such as blueberries, carrots, . . . ) or throughout periods of pollen dearth in the spring, summer or fall. For colonies of different size the dose can be proportionally adjusted to the amount of bees or nurse bees present.

This biweekly dose of isofucosterol can be administered in different ways to a beehive or the fed insects: This dose of isofucosterol can be administered to the colony in different formulations (incorporated in suspended, dissolved or emulsified form in a way that bees or the target animal readily ingests):
incorporated in the standard 1.5 to 3 pounds protein or pollen supplement patties administered per 2 weeks to a hive of 30000 bees wherein in one embodiment the composition comprises of isofucosterol or fucosterol or mixtures thereof in an amount from 0.01-5% of the diet, preferably from 0.01-2%, even more preferably from 0.01-1%, and even more preferably from 0.03-0.9% for honeybees and 0.03-0.8% for bumblebees as a percentage of the total weight of the pollen substitute composition.
more concentrated in small patty in which the concentration is then much higher e.g. up 33% sterol incorporated in or mixed with constituents that induce bees to eat the formulation such as pollen, sugar, oil/fat, honey, or protein or a mixture thereof, or
spread in the colony or fed outside of the colony in a feeding station as powder or paste with the isofucosterol incorporated in or mixed with constituents that induce bees to eat the formulation such as pollen, sugar, oil/fat, honey, or protein or a mixture thereof,
spread in the colony or fed outside of the colony in a feeding station a syrup, or liquid in which the isofucosterol is incorporated in or mixed with constituents that induce bees to eat the formulation such as pollen, sugar, oil/fat, honey, or protein or a mixture thereof,
In another embodiment the dose sterol molecules can be delivered through a device that is injecting the sterol composition into the colony for example on a pre-programmed basis.
Or any methods that can be used to deliver the indicated dose such that the bees ingest a chemical or nutrient such as are known to people skilled in the art.

In another aspect the sterol mixture is not administered through a patty or similar diet but the above multiplicity and ratio of sterols are dissolved in an aqueous or oily medium or nutrient slush or other edible form and administered to the colony as a liquid for drinking, liquid paste or spray in the hive or powder. In this embodiment the dry weight concentration of the sterols can be 0.01-100% dry weight (since the water carrier is evaporated from the administered medium).

Surprisingly, a bee colony fed a diet containing isofucosterol and a multiplicity of sterols including 24-Methylenecholesterol, cholesterol, and campesterol, beta-sitosterol or stigmasterol can support brood development for more than 4 cycles. The same diet without isofucosterol cannot do so, Importantly in our experiments the rate of brood production levels off to a stable level. This trajectory demonstrates that our diet supplies an adequate level of essential nutrients permitting indefinite brood production. This means that such diet can act as a pollen replacement to the bee colony over this period. Therefore, isofucosterol in this diet makes beekeeping independent of pollen resources in a natural setting or agricultural setting. In bumblebees, such diet with a multiplicity of sterols makes it possible for founding queen bees to rear larvae to adulthood, without need for pollen.

Creating such recipe, is not obvious from the literature. For example, Rasmont et al. (2005 J Econ Ent 98(3): 656-663) interpreted the data from Herbert et al. (1980) where honeybees were fed with artificial diets containing only one sterol to indicate that sitosterol and stigmasterol were an antifeedant to honeybees and not essential.

The inventors extended the utility of the invented diet from honeybees to other pollen eating insects with commercial relevance in biocontrol (e.g., lady bird beetles), insect biomass production (e.g. Black soldier fly) and pollination (Hoverflies).

There is an urgent need for changes to animal husbandry and livestock feeding which make use of waste materials created through food production. Additionally, methods for protecting crops from agricultural pests which do not rely on agrochemicals such as the production and release of natural insect predators such as ladybird beetles and hoverflies are an important means of creating integrated pest management strategies that reduce environmental impacts and protect biodiversity.

An important emerging means of making use of industrial agricultural waste is cultivation of fly larvae in waste material such as the black soldier fly (Hermetia illucens). Black soldier fly larvae are omnivorous generalists and can be fed with plant or animal waste, including feces, making them an advantageous means of converting waste biomass into feed for livestock. In agricultural production, these larvae and pupae are fed to poultry and fish. These insects acquire nutrients from the diet they consume as larvae which are valuable additions to the food chain, such as fatty acids and sterols (Boukid et al. 2021 Insects 12, 672. https://doi.org/10.3390/insects12080672). However, diets like industrial human waste have not been optimized for black soldierflies and are often missing key essential nutrients. For example, the development time, size, and mortality of BSF fed larvae are strongly influenced by the nature of the food they are cultivated on (Lalander et al. 2019. J Cleaner Production, https://doi.org/10.1016/j.jcelpro.2018/10.017). Delayed development times due to suboptimal diets reduce efficiency in rearing systems.

Another problem with existing rearing methods is suboptimal diets for life history stages. Holometabolous insects often consume different foods as larvae and adults. Each life history stage has substantially different nutritional requirements. What is fed to larvae in laboratory or industrial production settings may not be suitable for adult fecundity and survival.

In the wild, BSF larvae eat decaying organic material and adult BSF eat floral pollen. Like larvae, adult BSF also require protein; they produce more eggs when fed with protein (Bertinetti et al. 2019. Journal of Insect Science 19(1): 19; 1-7). Even though protein improves performance, egg mass size and hatching of eggs in protein fed laboratory reared flies is less than half of that of wild fed flies (Bertinetti et al. 2019). It is likely that certain nutrients are missing from laboratory diets which have not yet been identified (Bertinetti et al. 2019). Adult performance is important because adults produce eggs which are a rate-limiting step in industrial production (Cickova et al. 2015 Waste Management Volume 35, January 2015, 68-80).

Bertinetti et al. (2019) speculate that pollen has key nutrients that BSF need. Recently, black soldierflies have been shown to have much improved oviposition performance when fed with a diet that contains floral pollen (Thin and Kanoi. 2022. JARO 56 (2): 211-217). For example, oviposition and egg hatching is doubled and lifespan is increased by 30% when female black soldier flies are fed with pollen (Thin and Kanoi 2022). However, the components of pollen that cause this change are unknown.

Pollen feeding in other beneficial insects using in agriculture also impacts adult insect fecundity. This is particularly important in insects cultivated for biocontrol such as ladybird beetles (Coccinelidae) and hoverflies (Syrphidae). For example, ladybird beetle larvae will feed on pollen when aphids, their preferred prey, are not available (Berkvens et al. 2010 Eur. J. Entomol. 107: 189-195, 2010, Shuldiner-Harpez and Coll. 2017 J Insect Behav 30: 432-438). Importantly, pollen feeding by adult beetles has been shown to be required for fertility; male beetles that do not feed on pollen are unable to produce viable spermatozoa (Ugine et al. 2019 Ecology Letters 22: 275-283). Pollen feeding is also an essential component of the fecundity of hover flies (Syrphidae) which are important pollinators and predators of aphids (Hickman et al. 1995 New Zealand Journal of Zoology 22: 387-392). Female hoverflies are very selective of the types of pollen that they feed; the type of pollen influences their fecundity and the survival of their offspring (Amorous-Jimenez et al. 2014 BioControl 59:427-435).

Pollen contains many different phytosterols which are not found in other terrestrial plant or animal sources (Zu et al. 2020. New Phyt 230: 1169-1184). These sterols have a wide range of functions in the plant and outside the plant. Many phytosterols are produced by plants to inhibit feeding of insects on the plant.

The present inventors have surprisingly established that isofucosterol, a common sterol found in pollen, is an essential nutrient for pollen feeding insects. Isofucosterol delivered through a pollen-free diet increases the performance of adult and larval BSF. The present inventors have also identified that the main sterol component of pollens selected by adult female hoverflies is isofucosterol. The present inventors have further found that isofucosterol delivers higher growth and/or health performance in many invertebrates, in particular Holometabolous insects including bees and pollen feeding flies, moths/butterflies, and beetles.

Surprisingly, feeding cultivated Black Soldier Fly or beetle adults with a diet containing isofucosterol improves egg laying and egg hatching performance and adult longevity. The same effect can be obtained by feeding the larvae that will produce the brood stock with a diet containing isofucosterol (adults inherit substantial nutrition reserves from their larval/pupal stage). This means that a diet that includes isofucosterol can act as a pollen replacement and a form of supplemental nutrition to lab reared insect colonies. Therefore, this diet makes it possible to optimize larval development times and adult fecundity in industrial cultures of beneficial insects.

This is not obvious from the literature. Svoboda, a world leading researcher of insect sterols, teaches that in all but two species, cholesterol supplies a dietary need for sterol when it is present in diet (Svoboda. 1999. Critical Reviews in Biochemistry and Molecular Biology, 34(1):49-57). His summary did not recognize the need for sterols from pollen as essential nutrients for many pollen feeding insects. He did not recognize isofucosterol as a necessary sterol for holometabolous larval growth or adult insect fecundity.

Accordingly, a first aspect of the invention is a method for feeding bees such as honeybees and bumblebees and pollen or algae consuming animals such as ladybird beetles, black soldier fly, hoverfly, oysters, shrimp, and fish larvae comprising:
providing a pollen substitute formulation comprising a nutritionally effective amount of isofucosterol, fucosterol or a mixture thereof;
administering the pollen substitute formulation to animals such honeybees and bumblebees and pollen or algae consuming animals such as ladybird beetles, black soldier fly, hoverfly, oysters, shrimp, and fish larvae.

### Nutritionally Effective Amount

In a preferred aspect, the dosage of administration of the pollen substitute formulation containing isofucosterol or fucosterol or a mixture thereof and the further sterols from the group consisting of cholesterol, 24-Methylenecholesterol, campesterol, stigmasterol and beta-sitosterol, results in a total biweekly dosage of the above group of sterols to a colony of 30000 bees of 0.2 to 48 grams, preferably from 0.4 grams to 36 grams and even more preferably from 0.6 to 20 grams whereby the 100% of the sterols in the doses indicated above are divided as follows: isofucosterol-fucosterol is 10-60% of the sterol dose; the remainder of the sterols or multiplicity of sterols representing the remainder of the total sterol dose.

In a preferred embodiment the 100% doses of the group of sterols consisting of isofucosterol/fucosterol and/or cholesterol, and/or 24-Methylenecholesterol, and/or the phytosterols consisting of campesterol and/orstigmasterol and/or beta-sitosterol in the diet for a colony of 30.000 bees over a 14 day period is 0.3 gram to 20 gram of a composition of which 10-60% is isofucosterol and/or 0-50% is cholesterol and or 0-50% 24-Methylenecholesterol and/or 0-50% of a mixture of beta-sitosterol and/or stigmasterol and/or campesterol.

This represents a dose range per day of the “sterol composition” of 0.001% (Formula=0.3/14/1650×100) of the insect body weight consuming the food to 0.087% (Formula=20/14/1650×100) of the insect body weight consuming the food whereby of the sterol composition 10-60% is isofucosterol and/or 0-50% is cholesterol and or 0-50% 24-Methylenecholesterol and/or 0-50% of a mixture of beta-sitosterol and/or stigmasterol and/or campesterol.

This calculation is based on 50% of the bees being nurse bees each weighing 110 mg.

The overall dose can be proportionally adapted for larger or smaller insects, invertebrates, insect colonies and shorter or longer feeding intervals whereby the unit dose indicated here is for a 14 day period of colony of 30000 bees. (see table above from Keller et al., 2005b).

The same compositions and dose ranges apply to other pollen eating insects.

In another embodiment, some or all of these sterol moieties can be delivered as a prodrug such as a water-soluble sterol glycoside or a sterol sulphate or similar salt, or lipid-soluble form such as a sterol-ester or other similar prodrug forms in which the dose is adjusted to represent the fraction of the Molecular Weight of the respective sterol nucleus in the overall molecular weight of the conjugated sterol molecule.

The different methods of administration described above for isofucosterol can be applied to isofucosterol and the other sterol(s) described here.

To calculate the dose of the isofucosterol and groups of sterols to be delivered to other pollen eating insects (see above) as % body weight per day the following formula is used:

[30000/2]*0.110 gr=“Weight of the non-pollen supplement consuming insects (nurse bees and/or larvae) in a hive of 30000 bees” (@0.11 gram per nurse bee and/or larvae; @30000 bees in the hive 50% of which are nurse bees and/or larvae=1650 grams)

[“Dose of a given sterol or group of sterols delivered in a 14-day period to a colony of 30000 bees”/14]=“daily dose of sterol(s) administered”

“Daily dose administered in gram”/“Weight of the non-pollen supplement consuming insects (nurse bees & larvae) in a hive of 30000 bees in gram”×100=“% body weight of sterol(s) administered per day per gram of insect body weight”

Amount to be dosed of the sterols to a bumblebee colony: “% body weight of sterol(s) administered per day per gram of insect body weight”×“weight of the insects (nurse bees and larvae) to be fed”

On average—see table above ⅔ of the pollen consumed in a colony is consumed by nurse bees and ⅓ by larvae present (see table above).

In a preferred embodiment wherein the group of sterols consisting of isofucosterol/fucosterol and/or cholesterol, and/or 24-Methylenecholesterol, and/or the phytosterols consisting of campesterol and/or stigmasterol and/or beta-sitosterol is dosed via a 1.5 to 3 pound patty per 14 days to a colony of 30000 bees the patty contains
isofucosterol (0.01-2%, preferably 0.01-1%, more preferably 0.03-0.6% feed dry weight) or fucosterol (0.01-2%, preferably 0.01-1%, more preferably 0.03-0.6% feed dry weight) or a mixture thereof (total of 0.01-2%, preferably 0.001-1%, more preferably 0.03-0.6% feed dry weight) and at least one of the further sterols that are chosen from the group below (concentrations in % feed dry weight); resulting in a multiplicity of isofucosterol or fucosterol or a mixture thereof with at least one of the further sterols:
Cholesterol 0.001-2%, preferably 0.001%-1.5%, more preferably 0.06-1.2%, and/or
24-Methylenecholesterol 0.001-2%, preferably 0.001%-1.5%, more preferably 0.06-1.2% and/or
Beta-sitosterol 0.001-2%, preferably 0.001-1%, more preferably 0.03-0.6% and/or
Campesterol 0.001-2%, preferably 0.001-1%, more preferably 0.02-0.35% and/or
Stigmasterol 0.001-2%, preferably 0.001-1%, more preferably 0.01-0.2% and/or
   or any combination thereof, whereby the total concentration of sterols is in a range of 0.01 to 4% (dry weight).

In another aspect, the composition is administered to invertebrates of the Apis or Bombus genera, in particular honeybees or bumblebees.

In another aspect, the source of the isofucosterol, fucosterol or a mixture thereof is a pollen substitute tissue of one or more plant species selected from the group consisting of leaves, stems, roots, tubers, flowers, seeds, barks and fruits and combinations thereof.

In another aspect the source of the isofucosterol, fucosterol or a mixture thereof is an animal source, chemical synthesis or in vitro enzymatic synthesis, or a natural or metabolically engineered microorganism such yeast, algae or diatoms or a combination of such sources.

In another aspect, the source of the isofucosterol, fucosterol is an extract, an oil, or a refinement of a pollen substitute tissue of one or more plant species or a combination thereof.

In another aspect, the source of the isofucosterol, fucosterol is a pollen substitute tissue of one or more plant species selected from the group consisting of Solanaceae, Poaceae, Ranunculaceae, Fabaceae, Corylaceae.

In another aspect, the source of the isofucosterol, fucosterol or a mixture thereof is a pollen substitute source selected from the group consisting of:
a marine or freshwater algal species, in particular an extract, an oil or a refinement of Ulva lactuca;
a marine diatom species, in particular an extract, an oil or a refinement of Thalassiosira pseudonana, Thalassiosira rotula, or Chaetoceros muelleri; and
a fungus, in particular an extract, an oil or a refinement of Saccharomyces cerevesiae, or Yarrowia lipolytica.

In another aspect, the isofucosterol orfucosterol is chemically or enzymatically synthesized or obtained by genetically modified host organisms such as fungi, bacteria, or algae.

In another aspect, the source of the isofucosterol, fucosterol or a mixture thereof is selected from the group consisting of algae, plant, fungus, algae, diatom and combinations thereof and wherein source of the isofucosterol, fucosterol or a mixture thereof and of the at least one further sterol selected from the group consisting of cholesterol, 24-Methylenecholesterol, stigmasterol, campesterol, and beta-sitosterol is a pollen substitute tissue.

In another aspect, the isofucosterol, fucosterol or a mixture thereof is provided to a eusocial, or primitively eusocial, bee colony from a synthetic source.

In another aspect, the isofucosterol, fucosterol or a mixture thereof is provided as part of a pollen substitute composition, wherein the pollen substitute composition comprises:
proteins in an amount from 10 w % to 50 w %, preferably of 15 w % to 40 w %,
fatty acids in an amount from 1 w % to 20 w %, preferably of 2 w % to 12 w %,
carbohydrates in an amount from 20 w % to 90 w %, preferably of 30 w % to 70 w %,
optionally vitamins, and
optionally minerals,
   wherein the total amount of components and optionally further components add up to 100 w % and wherein the w % are related to the total dry weight of the composition.

Administration via a liquid or semi-liquid experiment:

In another aspect, the isofucosterol, fucosterol or a mixture thereof is provided as part of a liquid or semiliquid feed supplement to which optionally an appetite stimulant such as sugar, or any other appetite stimulant is added, wherein the liquid or semi liquid feed supplement composition comprises:
optionally proteins in an amount from 10 w % to 50 w %, preferably of 15 w % to 40 w %,
optionally fatty acids in an amount from 1 w % to 20 w %, preferably of 2 w % to 12 w %,
optionally carbohydrates in an amount from 20 w % to 90 w %, preferably of 30 w % to 70 w %,
optionally vitamins, and
optionally minerals,
optionally water or another solvent
   wherein the total amount of components and optionally further components add up to 100 w % and wherein the w % are related to the total dry weight of the composition.

In another aspect, the composition is essentially free of pollen (defined elsewhere in the text).

### Isofucosterol and Fucosterol

Isofucosterol is delta-5 sterol of the structural formula (I):

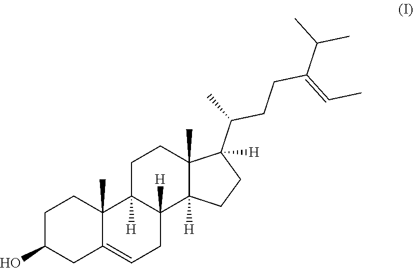

Fucosterol is a delta-5 sterol of the structural formula (II):

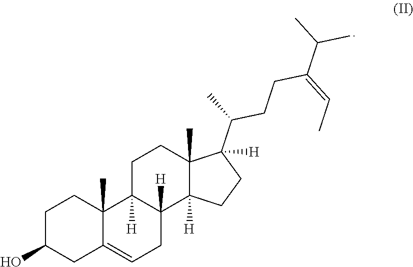

The structure of isofucosterol/fucosterol is described in https://en.wikipedia.org/wiki/Isofucosterol and https://pubchem.ncbi.nlm.nih.gov/compound/5281326

### 24-Methylenecholesterol

The structure of 24-Methylenecholesterol is described here: https://pubchem.ncbi.nlm.nih.gov/compound/24-Methylenecholesterol

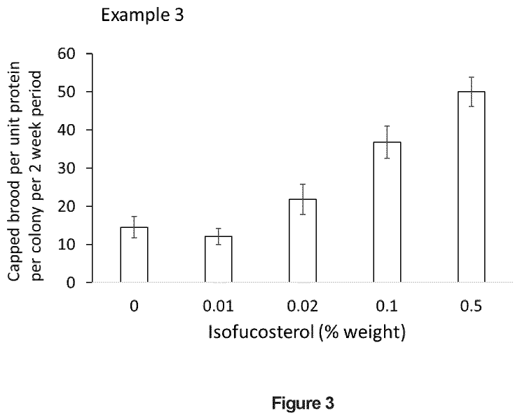

Isofucosterol and 24-Methylenecholesterol were synthesized by chemists skilled in the art of organic synthesis and the end product purified to 99% purity and characterized by LCMS, NMR, and Liquid chromatography (FIG. 3, 4, 5). Isofucosterol and 24-Methylenecholesterol can also be purified from natural sources, such as pollen collected by bees. Cholesterol was from a commercial source. B-sitosterol and other sterols were purified from commercially available soy phytosterols using standard methods.

### Physiologically Active Sterol Conjugates

Physiologically active sterol conjugates mean conjugates of sterols that can be metabolized by invertebrates or aquaculture or plant organisms.

The sterol molecules 24-Methylenecholesterol, beta-sitosterol, cholesterol, campesterol, isofucosterol/fucosterol, stigmasterol can be provided in the food in different conjugates and as a mixture of conjugates.

The concentration of sterol administered in the conjugate mix is calculated as follows:

‘Dose of sterol conjugate Molecular Weight of sterol conjugate’/‘Molecular Weight of sterol’×‘Dose of sterol desired’=‘dose of sterol conjugates desired’.

Examples of the different sterol conjugates are:
as a free alcohol
esterified with a fatty acid (such as but not limited to palmitic acid, stearic acid, linoleic, oleic, stearic, linolenic acid).
linked via the alcohol group to a fatty alcohol (sterol alkyl ethers),
esterified by an acid such as sulfuric acid (sterol sulfate) or acetic acid.
linked to a glucide (resulting in a steryl glycoside). The sterol group at the 3-OH position can be any sterol of the sterol group 24-Methylenecholesterol, beta-sitosterol, cholesterol, campesterol, isofucosterol/fucosterol, stigmasterol. The sugar glucose can be glucose, galactose, mannose, xylose, arabinose. A preferred embodiment is the glucose ester of the group of sterols.
esterified to g trans-hydroxycinnamate, ferulate (4-hydroxy-3-methoxycinnamate) and p-coumarate esters (see the figure of below of campesteryl ferulate as example of the steryl phenolate conjugates). A preferred embodiment is the coumaric acid ester of the group of sterols.

Preferred examples of sterol conjugates are:

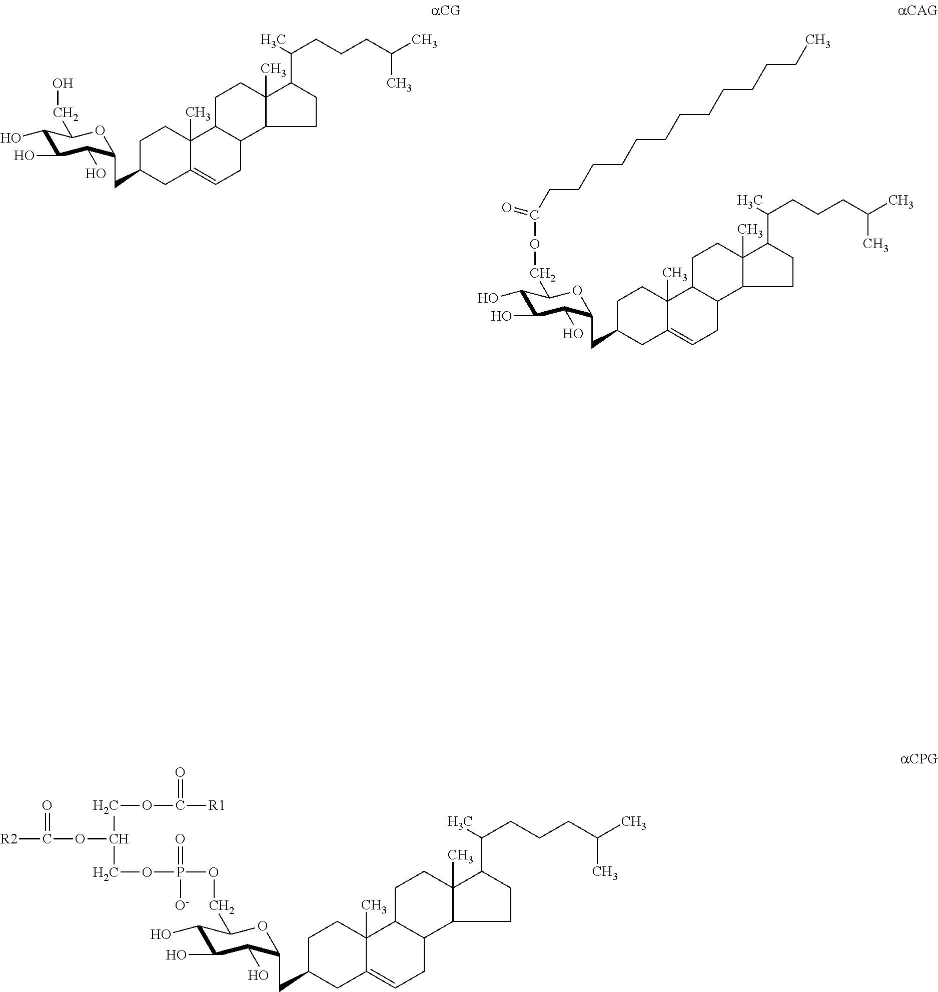

Examples of beta-sitosterol conjugates include:

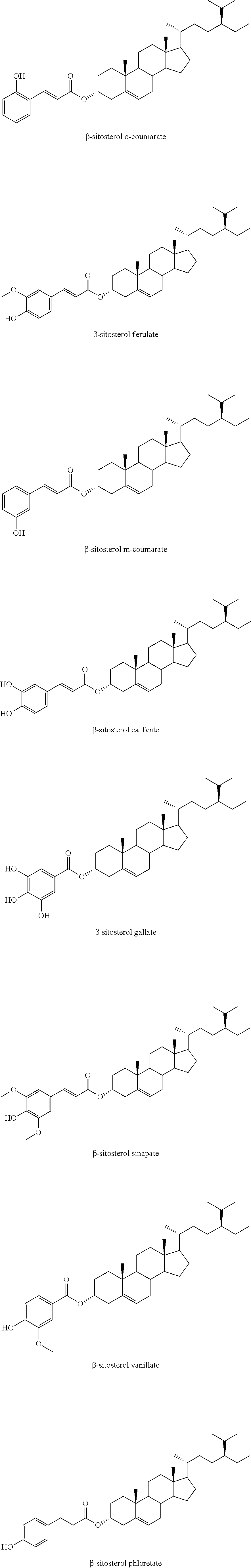

Similar to the beta-sitosterol examples above, conjugates with 24-Methylenecholesterol, isofucosterol, campesterol or cholesterol or stigmasterol can be used.

Further preferred sterol conjugates naturally occur in plants, such as (A) steryl ester (SE), (B) steryl glycoside (SG), (C) acyl steryl glycoside (ASG) with the structural formula:

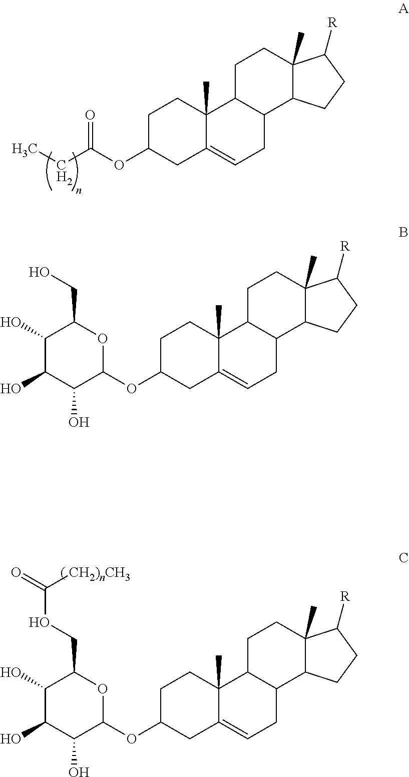

R-side chain, which can in the case of this patent can be of the group of cholesterol, isofucosterol, 24-Methylenecholesterol, campesterol, beta-sitosterol, stigmasterol.

Further examples include steryl-glycoside, steryl ester and acetylated steryl glycoside.

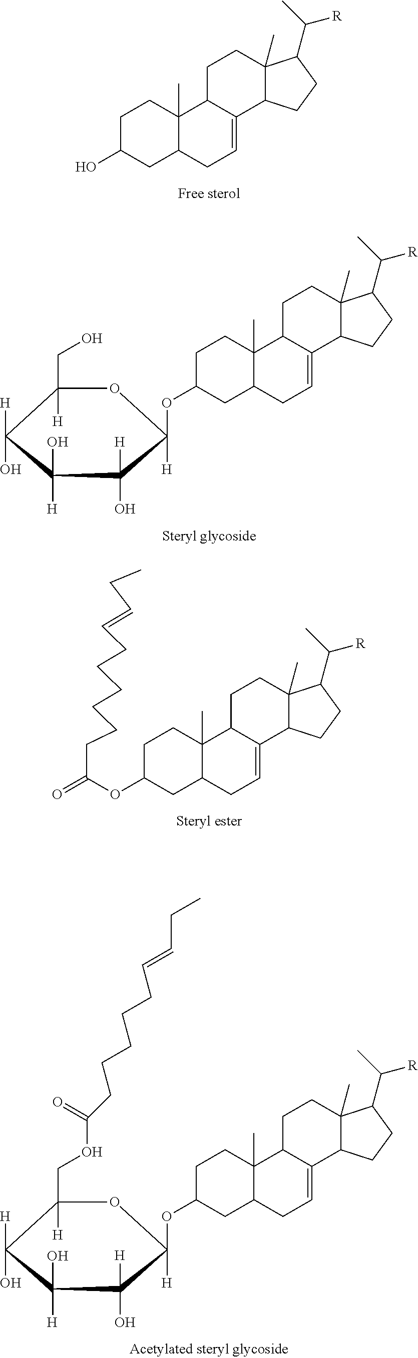

R is the side groups of the sterol. The sterol can be a delta-5 or delta-7 sterol.

Further examples of sterol conjugates include:

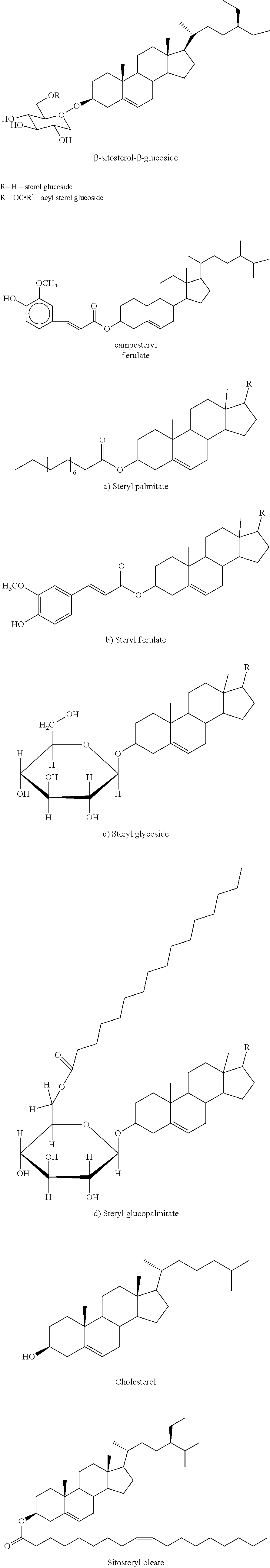

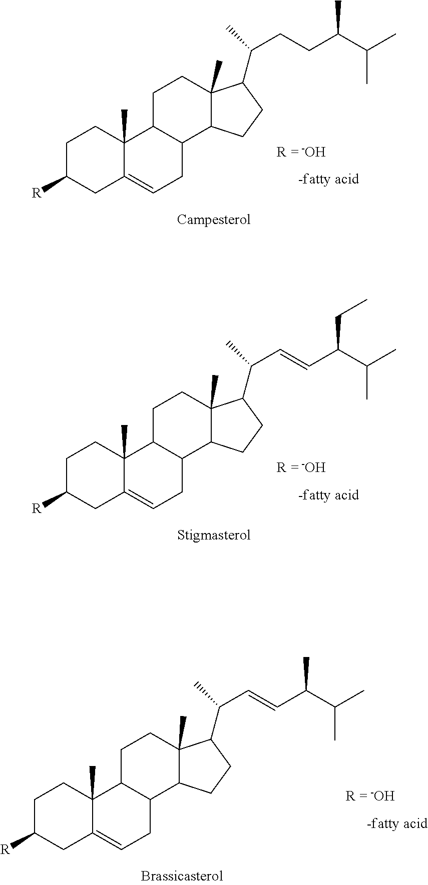

### Isofucosterol as Insect Nutrient

The present inventors have surprisingly found that isofucosterol is an essential bee and other pollen eating insect nutrient. Honeybees and bumblebees for example show the following levels of isofucosterol in their body composition:

TABLE 1
Isofucosterol composition of bees and potential food substrates
for bees as a percentage total bee-relevant phytosterols

| | Isofucosterol (% total) | Total phytosterol (μg/g) |
|---|---|---|
| Honeybee worker | 28.73 | 1673.75 |
| Bumblebee worker | 50.15 | 2101.26 |

### Pollen Substitute Composition

The feature “pollen substitute” means essentially free of pollen. However, minor amounts of pollen may be present in the compositions of the present inventions. In one embodiment, the amount of pollen is 15 w % or less, preferably 10 w % or less, even more preferably 5 w % or less and even more preferably 1 w % or less and even more preferably 0.1 w % or less as compared to the dry weight of the composition. The term pollen substitute and non-pollen are used interchangeably.

### Pollen Substitute Sources of Isofucosterol

Isofucosterol may be obtained from pollen substitute sources for example through
synthetic chemical synthesis; or
any pollen substitute plant source.

Examples of pollen substitute plant sources of isofucosterol include alga, fungus, bacteria, or animal parts that contain isofucosterol.

In one embodiment, the pollen substitute sources naturally contain isofucosterol.

In another embodiment, the pollen substitute sources of isofucosterol are organisms metabolically engineered to produce isofucosterol.

### Invertebrates

Invertebrates include
arthropods, such as insects, arachnids, crustaceans, and myriapods,
molluscs, such as chitons, snails, bivalves, squids, and octopuses,
annelid, such as earthworms and leeches; and
cnidarians, such as hydras, jellyfishes, sea anemones, and corals.

Preferred invertebrates are invertebrates that are cultured or farmed for purposes of human or animal nutrition such as honeybees, bumblebees, earthworms, meal worms, shrimps, prawns or crayfish, crickets, fly larvae ladybird beetles, black soldier flies, hoverflies, and oysters or other bivalves. Particularly preferred invertebrates are those of the Apidae or Bombidae family which are used as pollinators for agricultural or horticultural plants, such as
bees of the genus Apis and in particular Apis mellifera, Apis cerana, Apis dorsata or
bumblebees of the genus Bombus and in particular Bombus terrestris, B. impatiens, B. ignites
stingless honeybees of the tribe Meliponini

### Dosage and Concentration

The dose and concentrations in the examples described below are for feeding a colony of 30000 bees with a 1.5 pound to 3 pounds of a bee patty over a period of 14 days. The dose of the patty can be adapted to the size of the colony and the dose per 14 days can be repeated as desired by the beekeeper. The same doses can be delivered in embodiments whereby the administration is not through patties but through other forms as described above. The formulae for calculating the dose for different formulations, methods of administration or size of bee colonies or as dose/day as % of insect biomass are described above.

In one embodiment, the isofucosterol or the fucosterol is administered in an amount that is nutritionally effective for invertebrates, in particular for honeybees or bumblebees.

In one embodiment, nutritionally effective involves feeding a colony of 30000 bees with 1 pound to 1.5 to 3 pounds of a bee patty formulation over a period of 14 days that has a concentration of isofucosterol or fucosterol or mixtures thereof in an amount from 0.01-5%, preferably from 0.01 to 2%, even more preferably from 0.01-1% as a percentage of the total weight of the pollen substitute composition. In another embodiment, the concentration of isofucosterol or fucosterol or mixtures thereof is from 0.03-0.5% for honeybees or 0.03-1% for bumblebees as a percentage of the total weight of the pollen substitute composition. The dose of the patty can be adapted to the size of the colony and the dose per 14 days can be repeated as desired by the beekeeper.

In one embodiment, the cholesterol is administered in an amount that is nutritionally effective for invertebrates, in particular for honeybees or bumblebees. Preferably the cholesterol is administered in a concentration of 0.001-2%, preferably 0.001%-1.5%, more preferably 0.06-1.2% by dry weight of the total pollen substitute composition.

In one embodiment, the 24-Methylenecholesterol is administered in an amount that is nutritionally effective for invertebrates, in particular for honeybees or bumblebees. Preferably the 24-Methylenecholesterol is administered in a concentration of 0.001-2%, preferably 0.001%-1.5%, more preferably 0.06-1.2% by dry weight of the total pollen substitute composition.

In one embodiment, the sitosterol is administered in an amount that is nutritionally effective for invertebrates, in particular for honeybees or bumblebees. Preferably the sitosterol is administered in a concentration of 0.001-2%, preferably 0.001-1%, more preferably 0.03-0.6% by dry weight of the total pollen substitute composition.

In one embodiment, the campesterol is administered in an amount that is nutritionally effective for invertebrates, in particular for honeybees or bumblebees. Preferably the campesterol is administered in a concentration of 0.001-2%, preferably 0.001-1%, more preferably 0.02-0.35% by dry weight of the total pollen substitute composition.

In one embodiment, the stigmasterol is administered in an amount that is nutritionally effective for invertebrates, in particular for honeybees or bumblebees. Preferably the stigmasterol is administered in a concentration of 0.001-2%, preferably 0.001-1%, more preferably 0.01-0.2% by dry weight of the pollen substitute composition.

In one embodiment, the total concentration of sterol in the pollen substitute composition is in the range of 0.01% to 4% by dry weight of the pollen substitute composition.

### Pollen Substitute Composition

A further aspect of the invention is a pollen substitute composition comprising
a. proteins in an amount from 10 w % to 50 w %, preferably of 15 w % to 40 w %,
b. fatty acids in an amount from 1 w % to 20 w %, preferably of 2 w % to 12 w %,
c. carbohydrates in an amount from 30 w % to 90 w %, preferably of 30 w % to 70 w %,
d. optionally vitamins, and
e. optionally minerals,
wherein the total amount of components a) to e) and optionally further components add up to 100 w % and wherein the w % are related to the total dry weight of the composition,
wherein the pollen substitute composition further comprises a nutritionally effective amount of isofucosterol, fucosterol or a mixture thereof, and
wherein in a preferred embodiment the pollen substitute composition further comprises, at least one further sterol from the group consisting of cholesterol, 24-Methylenecholesterol, campesterol, stigmasterol and beta-sitosterol,
wherein, in a preferred embodiment, the total concentration of sterols is from 0.01 w % to 4 w %, preferably from 0.05 w % to 3 w % and even more preferably from 0.05 w % to 2 w %, and even more preferably from 0.05 w % to 1.5 w % as compared to the total weight of the pollen substitute composition.

### Use for Feeding

A further aspect of the invention is the use of the pollen substitute composition of the invention comprising a nutritionally effective amount of isofucosterol, fucosterol or a mixture thereof for feeding invertebrates or aquaculture organisms, wherein in a preferred embodiment the pollen substitute composition comprises a nutritionally effective amount of at least one further sterol, preferably at least two further sterols selected from the group consisting of cholesterol, 24-Methylenecholesterol, campesterol, stigmasterol and beta-sitosterol or a physiologically available conjugate thereof.

A further aspect of the invention is the use of the pollen substitute composition of the invention for feeding invertebrates or aquaculture organisms, wherein the pollen substitute composition comprises:
a. proteins in an amount from 10 w % to 50 w %, preferably of 15 w % to 40 w %,
b. fatty acids in an amount from 1 w % to 20 w %, preferably of 2 w % to 12 w %,
c. carbohydrates in an amount from 30 w % to 90 w %, preferably of 30 w % to 70 w %,
d. optionally vitamins, and
e. optionally minerals,
   wherein the total amount of components a) to e) and optionally further components add up to 100 w % and wherein the w % are related to the total dry weight of the composition,
   wherein the pollen substitute composition further comprises a nutritionally effective amount of isofucosterol, fucosterol or a mixture thereof, and
   wherein the pollen substitute composition further comprises, at least one further sterol from the group consisting of cholesterol, 24-Methylenecholesterol, campesterol, stigmasterol and beta-sitosterol, and
   wherein, in a preferred embodiment, the total concentration of sterols is from 0.01 w % to 4 w %, preferably from 0.05 w % to 3 w % and even more preferably from 0.05 w % to 2 w %, and even more preferably from 0.05 w % to 1.5 w % as compared to the total weight of the pollen substitute composition.

### Further Composition Components

A further aspect is a method for feeding invertebrates, in particular honeybees, wherein a pollen substitute composition is administered, wherein the pollen substitute composition comprises:
a. proteins in an amount from 10 w % to 50 w %, preferably of 15 w % to 40 w %,
b. fatty acids in an amount from 1 w % to 20 w %, preferably of 2 w % to 12 w %,
c. carbohydrates in an amount from 30 w % to 90 w %, preferably of 30 w % to 70 w %,
d. optionally vitamins, and
e. optionally minerals,
   wherein the total amount of components a) to e) and optionally further components add up to 100 w % and wherein the w % are related to the total dry weight of the composition,
   wherein the pollen substitute composition further comprises a nutritionally effective amount of isofucosterol, fucosterol or a mixture thereof, and
   wherein in a preferred embodiment the pollen substitute composition further comprises, at least one further sterol from the group consisting of cholesterol, 24-Methylene-cholesterol, campesterol, stigmasterol and beta-sitosterol,
   wherein, in a preferred embodiment, the total concentration of sterols is from 0.01 w % to 4 w %, preferably from 0.05 w % to 3 w % and even more preferably from 0.05 w % to 2 w % and even more preferably from 0.05 w % to 1.5 w % as compared to the total weight of the pollen substitute composition.

### The Same Composition and Ranges Apply to Bumblebees, Black Soldier Flies, Ladybird Beetles and Other Pollen Eating Insects.

### Isofucosterol as Insect Nutrient

The present inventors have surprisingly found that isofucosterol is an essential bee nutrient. Honeybees and bumble bees for example show the following levels of isofucosterol in their body composition:

TABLE 1
Isofucosterol composition of bees and potential food substrates
for bees as a percentage total bee-relevant phytosterols

| | Isofucosterol (% total) | Total phytosterol (μg/g) |
|---|---|---|
| Honeybee worker* | 28.73 | 1673.75 |
| Bumblebee worker** | 50.15 | 2101.26 |

### Non-Pollen Composition

The feature “non-pollen” means essentially free of pollen. However, minor amounts of pollen may be present in the compositions of the present inventions. In one embodiment, the amount of pollen is 15 w % or less, preferably 10 w % or less, even more preferably 5 w % or less and even more preferably 1 w % or less and even more preferably 0.1 w % or less as compared to the dry weight of the composition.

### Non-Pollen Sources of Isofucosterol

Isofucosterol may be obtained from non-pollen sources for example through
synthetic chemical synthesis; or
any non-pollen plant source.

Examples of non-pollen plant sources of isofucosterols include alga, fungus, bacteria, or animal parts that contain isofucosterol.

In one embodiment, the non-pollen sources naturally contain isofucosterol.

In another embodiment, the non-pollen sources of isofucosterol are metabolically engineered to produce isofucosterol.

### Invertebrates

Invertebrates include
arthropods, such as insects, arachnids, crustaceans, and myriapods,
molluscs, such as chitons, snail, bivalves, squids, and octopuses,
annelid, such as earthworms and leeches; and
cnidarians, such as hydras, jellyfishes, sea anemones, and corals.

Preferred invertebrates are invertebrates that are cultured or farmed for purposes of human or animal nutrition such as bees, bumble bees, earthworms, meal worms, shrimps, prawns or crayfish, crickets and fly larvae. Particularly preferred invertebrates are those of the Apidae or Bombidae family which are used as pollinators for agricultural or horticultural plants, such as
bees of the genus Apis and in particular Apis mellifera, Apis cerana, Apis dorsata or
bumble bees of the genus Bombus and in particular Bombus terrestris, B. impatiens, B. ignites
stingless honey bees of the tribe Meliponini

### Dosage and Concentration

The isofucosterol or the fucosterol is administered in an amount that is nutritionally effective for invertebrates, in particular for bees or bumble bees.

In one embodiment, nutritionally effective means a concentration of isofucosterol or fucosterol or mixtures thereof in an amount from 0.01-5% of the diet, preferably from 0.01-1% as a percentage of the total weight of the pollen substitute composition. In another embodiment, the concentration of isofucosterol or fucosterol or mixtures thereof is from 0.03-0.5% for honeybees or 0.03-0.8% for bumblebees as a percentage of the total weight of the pollen substitute composition.

In another embodiment, the dosage of isofucosterol that a beekeeper would use for a colony of honeybees should be approximately 0.1-0.5% of the total weight of the diet. If each nurse bee weighs 120 mg and consumes 10-15 mg of food per day, and if a colony of bees is made up of approximately 50% nurse or young adult worker bees, this would usually be between 5-25 mg of isofucosterol per colony per day. In another embodiment, for a bumblebee colony composed of 300 bees, the diet should include isofucosterol in quantities of 0.3-0.8% of the total weight of the diet. If each bumblebee weighs approximately 200 mg and consumes 20 mg of food per day, and if all bees consume the food, then the effective dose of isofucosterol would usually be 2-5 mg per day per colony.

### EXAMPLES

### Comparative Example 1: Isofucosterol Levels in Commercial Bee Feed

Commercially available non-pollen bee feed compositions do not comprise isofucosterol as shown in Table 1 below.

TABLE 1
Commercially available honeybee feeds

| | | Total phytosterols |
|---|---|---|
| | Isofucosterol | (microg/g) |
| UltraBee | below detection limit | 2147.29 |
| MegaBee | below detection limit | 1489.84 |
| AP23 | below detection limit | 1340.88 |
| BeePro | below detection limit | 509.18 |
| Broodbuilder | below detection limit | 280.38 |
| FeedBee | below detection limit | 844.56 |

0.001 w % is the isofucosterol detection limit
*from Svoboda et al 1980 JInsPhys 26: 291-294
**methods for analysis from Zu et al. 2021 New Phyt 230: 1169-1184
Total calculated as the sum of the quantities of bee-relevant phytosterols: 24MCHO = 24-Methylenecholesterol.
CAMPE = campesterol.
STIGM = stigmasterol.
b-SITO = b-sitosterol.
ISOFUCO = isofucosterol

### Example 1—Preference Essay: Bees Prefer Specific Concentrations of Isofucosterol in Foods

Newly emerged adult worker honeybees (Apis mellifera) or adult worker bumblebees (Bombus terrestris) were tested in a two-choice preference assay in which bees had access to two diets and ad libitum access to water.

One treatment diet contained the isofucosterol and the other contained no sterol. Newly emerged bees were removed from the brood frame and cohorts of 30 bees per replicate were housed in plastic rearing cages. In all experiments, 10 cohorts of ˜30 bees each were used for each treatment group. In all diets carbohydrate was maintained at 60% using sucrose and fat was maintained at 8%. Consumption of each diet was measured every 24 h for 5 days. Preference index was calculated as (amount of treatment consumed−amount of control consumed)/(total amount of food consumed).

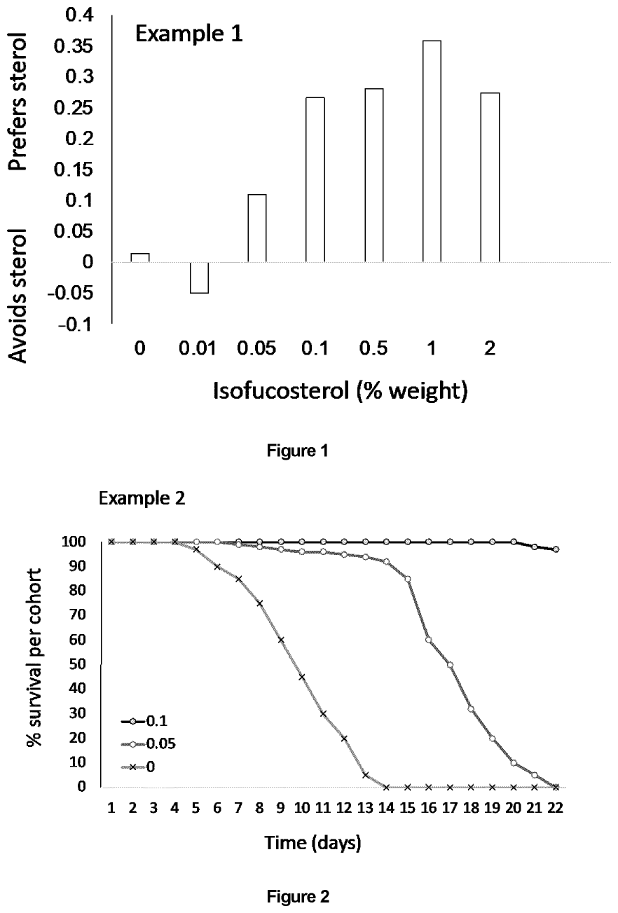

In Example 1, cohorts of bees were given a choice of diet with or without isofucosterol. Bees preferred to consume food that contained at least 0.05% isofucosterol in the diet, as shown in FIG. 1.

### Example 2—Survival: Bees Live Longer on Foods Containing Isofucosterol

Newly emerged adult worker honeybees fed with a diet treatment and ad libitum access to water. The treatment diet contained the isofucosterol. Newly emerged bees were removed from the brood frame and cohorts of 30 bees per replicate were housed in plastic rearing cages. In all experiments, 10 cohorts of ˜30 bees each were used for each treatment group. In all diet's carbohydrate was maintained at 60% using sucrose and fat was maintained at 8%. Consumption of each diet was measured every day over the course of the experiment. The number of bees alive in the box was counted each day for 14 days.

Example 2 represents the survival of cohorts of bees confined to feed on diets containing specific concentrations of isofucosterol (0%, 0.5% and 1% weight of diet), as shown in FIG. 2.

### Example 3—Brood Production: Honeybees Produce More Brood with Isofucosterol and Produce Brood for Longer Periods of Time

Honeybees: Fully functional insulated styrofoam APIDEA nucs comprised 5 mini frames populated with adult workers and 1 mated laying queen bee were populated with 300-400 ml of young adult workers (˜N<1,000 bees of mixed ages).

The colony was located in an enclosed glasshouse with ventilation which did not permit the honeybees to forage on nectar or pollen. Each treatment was tested with 3-6 colonies; each colony was fed with a 60-100 g patty (solid diet) on the top feeder fitted with a mesh floor. Diet was fed on the first day and again on day 6; the quantity consumed was measured on day 6 and day 15. If no larvae or eggs/queen are observed by day 6 then the experiment is terminated. The number of capped brood cells was counted on day 15. The number of bee seams was estimated during each inspection. Sugar syrup (34%) and water was provided in feeders inside the tent to prevent carbohydrate starvation and to stimulate foraging activity.

In Example 3, bees were fed with a diet containing 10-18% protein, 6% fat, 1% vitamins/minerals and >75% carbohydrates.

FIG. 3 exhibits the threshold of example 3 for the influence of isofucosterol in bee diet. As the concentration of isofucosterol increased, the amount of brood produced in each colony increased (N>3 colonies/treatment). The pupae, and the number of new adults was counted over the entire 10-week period.

### Example 4—Brood Production: Honeybees Produce More Brood with Isofucosterol and Produce Brood for Longer Periods of Time

Honeybees: Fully functional insulated styrofoam Apidea™ nucs comprised 5 mini frames populated with adult workers and 1 mated laying queen bee were populated with 300-400 ml of young adult workers (˜N<1,000 bees of mixed ages).

The colony was located in an enclosed glasshouse with ventilation which did not permit the honeybees to forage on nectar or pollen. Each treatment was tested with 3-6 colonies; each colony was fed with a 60-100 g patty (solid diet) on the top feeder fitted with a mesh floor. Diet was fed on the first day and again on day 6; the quantity consumed was measured on day 6 and day 15. If no larvae or eggs/queen are observed by day 6 then the experiment is terminated. The number of capped brood cells was counted on day 15. The number of bee seams was estimated during each inspection. Sugar syrup (34%) and water was provided in feeders inside the tent to prevent carbohydrate starvation and to stimulate foraging activity.

In Example 3, bees were fed with a diet containing 10-18% protein, 6% fat, 1% vitamins/minerals and >75% carbohydrates.

FIG. 9 exhibits the threshold of example 3 for the influence of isofucosterol in bee diet. As the concentration of isofucosterol increased, the amount of brood produced in each colony increased (N>3 colonies/treatment). The pupae, and the number of new adults was counted over the entire 10-week period.

### Example 4A: Long Term Apidea Experiment with Bees Fed a Multiplicity of Sterols Including Isofucosterol and 24-Methylenecholesterol

Honeybees: Fully functional insulated styrofoam Apidea™ nucs comprised 3-5 mini frames populated with adult workers and 1 mated laying queen bee were populated with 300-400 ml of young adult workers (˜N<1,000 bees of mixed ages).

The colonies are located in an enclosed screenhouse with ventilation which did not permit the honeybees to forage on nectar or pollen. Each treatment was tested with 3-6 colonies, each colony was fed ad libitum with the solid diet on the top feeder fitted with a mesh floor, and the quantity consumed was assessed at every feeding. The number of capped brood cells was assessed every 12 days. The number of bee seams was recorded during each inspection. If the colony reaches maximal size for the Apidea box, a super is added. Sugar syrup (34%) and water was provided in feeders inside the tent to prevent carbohydrate starvation and to stimulate foraging activity.

In Example 4A, bees were fed with a diet containing 15-30% protein, 4-12% fat, 1% vitamins/minerals and >40% carbohydrates (Diet 1).

The experiments included the following treatments:
Diet 1: the above diet 1 to which no sterols are added
Diet 2=Diet 1 to which isofucosterol, 24-Methylenecholesterol, campesterol, beta-sitosterol, stigmasterol, and cholesterol is added in ratios and concentrations as per preferred embodiment above
Diet 3=Diet 2 but without inclusion of 24-Methylenecholesterol
Diet 4=Diet 2 but without inclusion of isofucosterol
Diet 5=a pollen-based patty (pollen patty) consisting of 60.5% pollen (fresh frozen honeybee collected pollen from BioBest, Antalya, Turkey), 25.2% powdered sugar, and 14.3% honey
Diet 6=Diet 2 but without inclusion of cholesterol
Diet 7=Diet 2 but without inclusion of beta-sitosterol, stigmasterol and campesterol
DIET 8=a commonly used commercially available diet

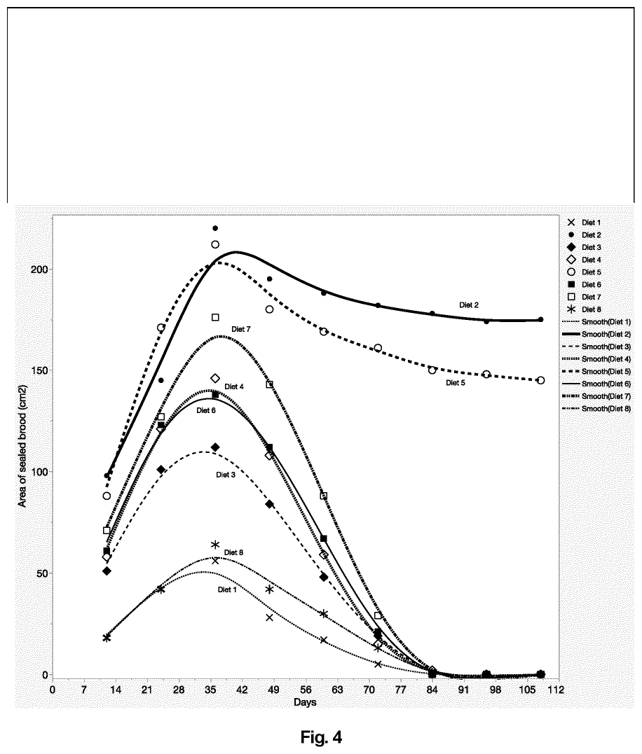

FIG. 4—results of experiment 4A: Mean area of sealed brood (cm2) assessed every 12 days over a 15-week period. Each colony was fed one diet treatment: Diet 1 (crosses, thin dotted line), Diet 2 (full circles, thick full line), Diet 3 (full diamonds, thin dashed line), Diet 4 (empty diamonds, thick dotted line), Diet 5 (open circles, thick dashed line), Diet 6 (full squares, thin full line), Diet 7 (empty squares, thick dashed and dotted line), and Diet 8 (asterisks, thin dashed and dotted line).

### Example 4B: Long Term Apidea Experiment with Bees Fed a Multiplicity of Sterols without Isofucosterol, but Including 24-Methylenecholesterol

Honeybees: Fully functional insulated styrofoam Apidea™ nucs comprised 3-5 mini frames populated with adult workers and 1 mated laying queen bee were populated with 300-400 ml of young adult workers (˜N<1,000 bees of mixed ages).

The colonies are located in an enclosed screenhouse with ventilation which did not permit the honeybees to forage on nectar or pollen. Each treatment was tested with 3-6 colonies, each colony was fed ad libitum with the solid diet on the top feeder fitted with a mesh floor, and the quantity consumed was assessed at every feeding. The number of capped brood cells was assessed every 12 days. The number of bee seams was recorded during each inspection. If the colony reaches maximal size for the Apidea box, a super is added. Sugar syrup (34%) and water was provided in feeders inside the tent to prevent carbohydrate starvation and to stimulate foraging activity.

In Example 4B, bees were fed with a diet containing 15-30% protein, 4-12% fat, 1% vitamins/minerals and >40% carbohydrates (Diet 1).

The experiments included the following treatments:

Diet 1=a diet containing 15-30% protein, 5-10% fat, 1% vitamins/minerals and >40% carbohydrates, to which no sterols are added.

Diet 2=pollen patty (60.5% honeybee collected mixed pollen pellets, 25.2% powdered sugar, and 14.3% honey).

Diet 3=Diet 4 but without inclusion of 24-Methylenecholesterol.

Diet 4=Diet 1 to which 24-Methylenecholesterol, campesterol, beta-sitosterol, stigmasterol, and cholesterol are added in ratios and concentrations as per preferred embodiment above.

Diet 5=a commonly used commercially available diet.

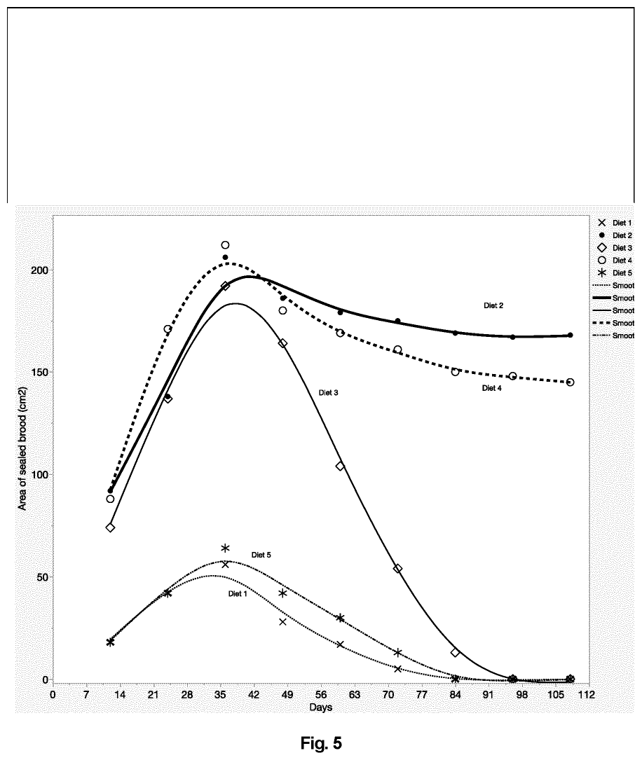

FIG. 5 shows the result of experiment 4B: Mean area of sealed brood (cm2) assessed every 12 days over a 15-week period. Each colony was fed one diet treatment: Diet 1 (crosses, thin dotted line), Diet 2 (full circles, thick full line), Diet 3 (empty diamonds, thin line), Diet 4 (empty circles, thick dashed line), Diet 5 (asterisks, thin dashed and dotted line).

### Example 4C: Long Term Apidea Experiment with Bees Fed a Multiplicity of Sterols Whereby the Total Concentration of Sterols in the Diet is Kept Constant and the Presence (Concentration) of Specific Sterols is Varied Between Diets

Honeybees: Fully functional insulated styrofoam Apidea™ nucs comprised 3-5 mini frames populated with adult workers and 1 mated laying queen bee were populated with 300-400 ml of young adult workers (˜N<1,000 bees of mixed ages).

The colonies are located in an enclosed screenhouse with ventilation which did not permit the honeybees to forage on nectar or pollen. Each treatment was tested with 3-6 colonies, each colony was fed ad libitum with the solid diet on the top feeder fitted with a mesh floor, and the quantity consumed was assessed at every feeding. The number of capped brood cells was assessed every 12 days. The number of bee seams was recorded during each inspection. If the colony reaches maximal size for the Apidea box, a super is added. Sugar syrup (34%) and water was provided in feeders inside the tent to prevent carbohydrate starvation and to stimulate foraging activity.

The experiments included the following treatments:

Diet 1=a diet containing 15-30% protein, 5-10% fat, 1% vitamins/minerals and >40% carbohydrates, to which no sterols are added.

Diet 2=Diet 1 to which 24-Methylenecholesterol and isofucosterol are added at lower concentrations than preferred embodiment above, and campesterol, beta-sitosterol, stigmasterol, and cholesterol is added in ratios and concentrations as per preferred embodiment above.

Diet 3=Diet 2 but with greater concentrations of 24-Methylenecholesterol and isofucosterol, as per preferred embodiment above, cholesterol, and lower concentrations of campesterol, beta-sitosterol and stigmasterol, to maintain similar total sterol percentage as in diet 2.

Diet 4=similar to diet 3 but without inclusion of 24-Methylenecholesterol and of cholesterol, maintaining total sterol percentage as in diet 7.

Diet 5=similar to diet 3 but without inclusion of isofucosterol.

Diet 6=similar to diet 3 but without inclusion of 24-Methylenecholesterol and of isofucosterol.

Diet 7=similar to diet 3 but without inclusion of 24-Methylenecholesterol, isofucosterol, and cholesterol, maintaining total sterol percentage as in diet 4.

Diet 8=pollen patty (60.5% honeybee collected mixed pollen pellets, 25.2% powdered sugar, and 14.3% honey).

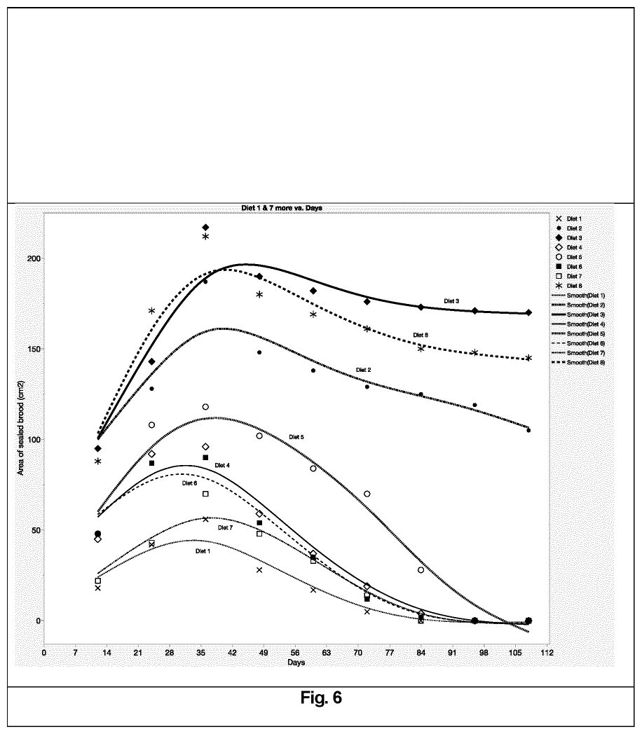

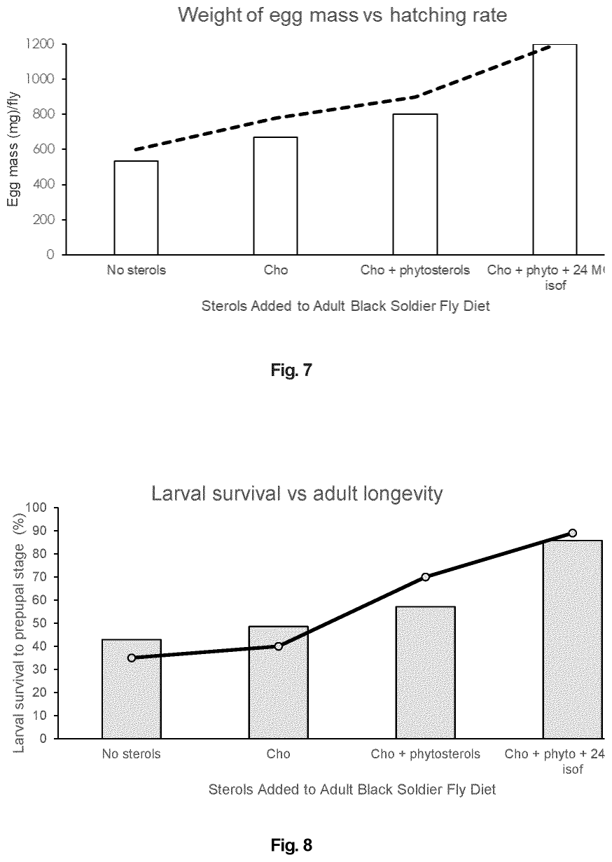

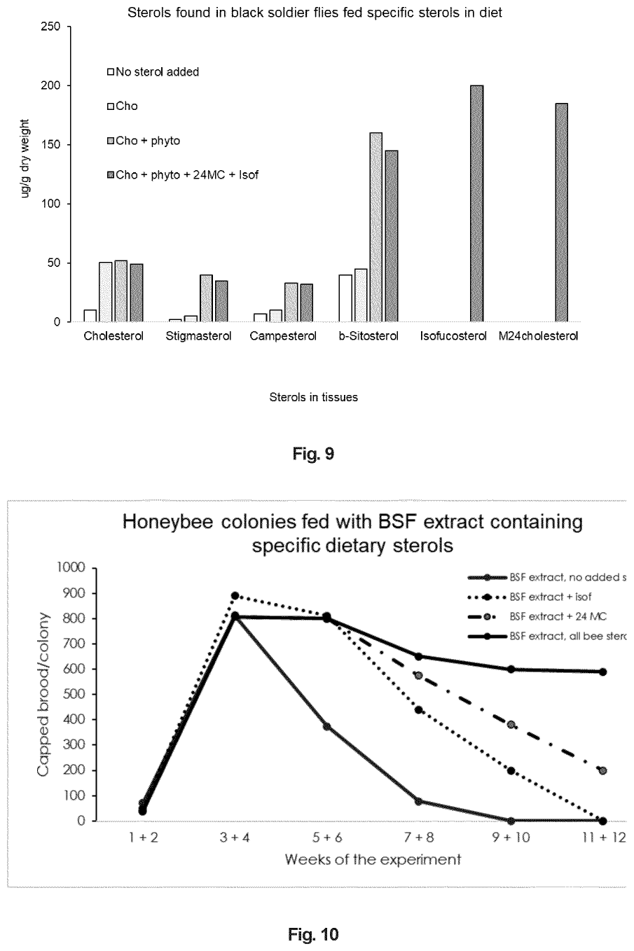

FIG. 6: Results of Example 4C: Results of a long-term feeding experiment in Apidea colonies with bees fed a multiplicity of sterols whereby the total concentration of sterols in the diet is kept constant and the presence (concentration) of specific sterols is varied between diets.

### Example 5: Black Soldier Fly Experiments

FIG. 7 shows the results of Example 5A: Feeding adult Black soldier flies with a diet containing a multiplicity of sterols: effect on hatching rate of the eggs laid and the weight of the egg mass laid. Adult survival and number of egg masses laid from a population fed with a pollen substitute diet (as specified in US2019/0090507 to Apix Biosciences) was measured daily using the methods of rearing described in Thinn and Kainoh 2022. JARQ 56 (2), 211-217 (2022).

FIG. 8 shows the results of Example 5B: Feeding adult Black soldier flies with a diet containing a multiplicity of sterols: effect on adult longevity and larval survival to prepupae stage. Black soldier fly (BSF) larvae were fed with a diet containing 22% protein, 4% fat as described in Hogsette 1992. J. Econ. Entomol. 85(6): 2291-2294 until ecclosion. Sterols were sourced as pure compounds added directly to diet to a total quantity of 0.1%. Larvae and adult survival over a 50 day period measured as in Georgescu et al., Eur. J. Entomol. 118: 297-306, 2021.

FIG. 9 shows the results of Example 5C: Feeding adult Black soldier flies with different diets containing a multiplicity of sterols: sterols found in in the tissues of black soldier flies fed with a multiplicity of sterols. Sterols were added to diet. Measurement of sterols in tissues was performed after saponification of BSF tissues using GC-MS as described in Boukid et al. 2022. Insects 12, 672.

### Example 6: Black Soldier Fly Experiments

Changing the nutritional composition of a BFS larva for a target species (honeybee) by incorporating a multiplicity of sterols in the diet of the BFS larvae, making an feed formulation containing larvae and feeding those larvae the target species. Black soldier fly larvae were fed with a diet as in FIG. 10. Sterols needed by honeybees were added to diet in quantities specified as in Diet 2 or as single sterols (24-Methylenecholesterol, 24MC or isofucosterol). One group did not have sterol added directly to the diet. Extracts were made using hexane from freeze-dried BSF larvae. The hexane solvent containing the fat fraction was added to the diet; the hexane was allowed to evaporate before the diet was used to feed the larvae.

This example generally shows how by feeding a multiplicity of sterols adapted to meet the needs of a target species can benefit the performance of the target species. Since BFS grown on different waste streams does not contain optimal sterol profiles for algae or plankton eating cultured fish, crustacea and cultured marine invertebrates and their larvae, this method of adding fucosterol or isofucosterol, 24 methylene cholesterol (all enriched in algae but absent in current non algal artificial diets for above species diets) to BFS diets and then feeing lipid or protein or total extracts of these BFS larvae to algae eating aquaculture organisms is a method to improve the performance of aquaculture artificial diets for organism normally feeding on plankton and larvae and requiring isofucosterol/fucosterol and/or methylene cholesterol.

FIG. 10 shows the results of Example 6: Feeding honeybee colonies in an Apidea experiment with a diet containing an extract of Black soldier flies that were fed a multiplicity of sterols.

1. A method for feeding invertebrates or aquaculture organisms comprising:
providing a non-pollen composition comprising a nutritionally effective amount of isofucosterol, fucosterol or a mixture thereof, and
administering the non-pollen composition to invertebrates;
wherein
the invertebrates are pollen eating insects, preferably insects of the orders Hymenoptera and Coleoptera, more preferably honeybees, bumblebees, black soldier flies, hoverflies, or ladybirds; and
the aquaculture organisms are plankton and algae eating aquaculture organisms, preferably fish, fish larvae, oysters, clams, molluscs, gastropods, or crustacea.

2. (canceled)

3. The method of claim 1, wherein the nutritionally effective amount of isofucosterol, fucosterol or a mixture thereof is a daily dose of 0.0006 w % to 0.052 w % of the life bodyweight of the invertebrates or aquaculture organisms.

4. The method of claim 1, wherein the nutritionally effective amount of isofucosterol, fucosterol or a mixture thereof is from 10 w % to 60 w % of the total amount of sterols of the group of isofucosterol, fucosterol, cholesterol, 24-Methylenecholesterol, campesterol, stigmasterol and beta-silosterol in the total diet of the invertebrates or aquaculture organisms or the pollen substitute composition.

5. The method of claim 1, wherein the isofucosterol, fucosterol or a mixture thereof is administered in a ratio of 0.14 g to 12 g of isofucosterol, fucosterol or a mixture thereof per 30000 bees per period of two weeks.

6. The method of claim 1, wherein the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-silosterol in the total diet of the invertebrates or aquaculture organisms or the pollen substitute composition.

7. The method of claim 1,
wherein the nutritionally effective amount of isofucosterol, fucosterol or a mixture thereof is an administration ratio of 0.2 g to 48 grams per 30000 bees per a time period of two weeks, and
wherein the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-silosterol in the total diet of bees or of the pollen substitute composition.

8. The method of claim 1,
wherein the isofucosterol, fucosterol or a mixture thereof is administered in a ratio of 0.4 g to 36 g per 30000 bees per a time period of two weeks, and
wherein the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-silosterol in the total diet of bees or of the pollen substitute composition.

9. The method of claim 1,
wherein the isofucosterol, fucosterol or a mixture thereof is administered in a ratio of 0.6 g to 20 g per 30000 bees per a time period of two weeks, and
wherein the isofucosterol, fucosterol or a mixture thereof is administered in an amount from 10 w % to 60 w % of the total amount of sterols of the group of isofucosterol, fucosterol, cholesterol, 24-Methylenecholesterol, campesterol, stigmasterol and beta-silosterol in the total diet of bees or of the pollen substitute composition.

10. The method of claim 1, wherein the isofucosterol, fucosterol or a mixture thereof is administered in an amount of 0.001 w % to 0.087 w % of the life weight of the invertebrates or aquaculture organisms per day.

11. The method of claim 1, wherein the nutritionally effective amount is:
isofucosterol in an amount of 10 w % to 60 w %,
cholesterol in an amount of 0 w % to 50 w %,
24-Methylenecholesterol in an amount of 0 w % to 50 w %,
beta-silosterol, stigmasterol and/or campesterol in an amount of 0 w % to 50 w %
as compared to the total amount of isofucosterol, fucosterol, cholesterol, 24-Methylenecholesterol, beta-silosterol stigmasterol and/or campesterol.

12. The method of claim 1, wherein the composition is a whole invertebrate diet, a part of an invertebrate diet, or a dietary supplement.

13. The method of claim 1, wherein the composition is administered to invertebrates of the Apidae families, in particular honey bees (Apini), bumble bees (Bombini) or stingless honey bees (Meliponini).

14. The method of claim 1, wherein the composition is administered
in solid form such as a patty or in liquid form such as a solution or spray;
inside or outside the hive.

15. The method of claim 1, wherein the source of the isofucosterol, fucosterol or a mixture thereof is a non-pollen tissue of one or more plant species selected from the group consisting of leaves, stems, roots, tubers, flowers, seeds, barks and fruits and combinations thereof.

16. The method of claim 1, wherein the source of the isofucosterol, fucosterol or a mixture thereof is an extract, an oil, or a refinement of a non-pollen tissue of one or more of a plant species or a combination thereof.

17. The method of claim 1, wherein the source of the isofucosterol, fucosterol or a mixture thereof non-pollen tissue of one or more plant species selected from the group consisting of Solanaceae, Poaceae, Ranunculaceae, Fabaceae, Corylaceae.

18. The method of claim 1, wherein the source of the isofucosterol, fucosterol or a mixture thereof is an extract, an oil, or a refinement source of the isofucosterol, fucosterol or a mixture thereof is a non-pollen source selected from the group consisting of:
a marine or freshwater algal species, in particular an extract, an oil or a refinement of Ulva lactuca
a marine diatom species, in particular an extract, an oil or a refinement of Thalassiosira pseudonana, Thalassiosira rotule, or Chaetoceros muelleri; and
a fungus, in particular an extract, an oil or a refinement of yeast such as Saccharomyces cervesiae or Yarrowia lipolytica.

19. The method of claim 1, wherein the source of the isofucosterol is chemically or enzymatically synthesized or obtained by genetically modified host organisms such as fungi, bacteria, or algae.

20. The method of claim 1, wherein the source of the isofucosterol is chemically or enzymatically synthesized or obtained by genetically modified host organisms such as fungi, bacteria, or algae.

21. The method of claim 1, wherein the isofucosterol, fucosterol or a mixture thereof is provided to a eusocial bee colony from a synthetic source.

22. The method of claim 1, wherein the isofucosterol, fucosterol or a mixture thereof is provided as part of a pollen substitute composition, wherein the pollen substitute composition comprises:
a. proteins in an amount from 10 w % to 50 w %, preferably of 20 w % to 40 w %;
b. fatty acids in an amount from 1 w % to 20 w %, preferably of 4 w % to 12 w %;
c. carbohydrates in an amount from 30 w % to 90 w %, preferably of 5 w % to 15 w %;
d. optionally vitamins; and
e. optionally minerals,
wherein the total amount of components a) to e) and optionally further components add up to 100 w % and wherein the w % are related to the total dry weight of the composition.

23. The method of claim 1, wherein the composition comprises of isofucosterol or fucosterol or mixtures thereof in an amount from 0.01-5% of the diet, preferably from 0.01-1% and even more preferably from 0.03-0.5% for honeybees and 0.03-0.8% for bumblebees as a percentage of the total weight of the pollen substitute composition.

24. The method of claim 1, wherein the composition is essentially free of pollen.

25. (canceled)

26. The method of claim 1, wherein the pollen substitute composition is administered as a concentrated patty, wherein the concentration of isofucosterol, fucosterol or a mixture thereof is from 10 w % to 33 w % as compared to the total weight of the pollen substitute composition.

27. The method of claim 1, wherein the composition comprises a bee inducing constituent selected from the group consisting of pollen, sugar, oil or fat, honey, or protein or a mixture thereof.

28. The method of claim 27, wherein the concentration of the bee inducing constituent is from 1 w % to 20 w %, preferably from 2.5 w % to 15 w %, even more preferably from 5 w % to 10 w % as compared to the total weight of the pollen substitute composition.

29. The method of claim 1, wherein the pollen substitute composition is in liquid form or in powder form.

30. The method of claim 1, wherein the nutritionally effective amount of isofucosterol, fucosterol or a mixture thereof is from 0.01 w % to 99 w % as compared to the total dry weight of the pollen substitute composition.
